(19) United States
(12) Patent Application Publication
(10) Pub. No.: US 2023/0105884 A1
(43) Pub. Date: Apr. 6, 2023

(54) SOLUTION FOR PROVIDING END WALL ON METAL TRIM PROFILE

(71) Applicant: CISMA SOLUTIONS ApS, Silkeborg (DK)

(72) Inventor: Paw NEDERGAARD, Holsted (DK)

(73) Assignee: CISMA SOLUTIONS ApS, Silkeborg (DK)

(21) Appl. No.: 17/911,190

(22) PCT Filed: Mar. 11, 2021
(86) PCT No.: PCT/EP2021/056198

§ 371 Date: Sep. 13, 2022

(30) Foreign Application Priority Data
Mar. 13, 2020 (EP) 20163089.4

(51) Int. Cl. B21D 53/88; B21D 22/26

(52) U.S. Cl. CPC B21D 53/88; B21D 22/26

(57) ABSTRACT

A method including providing a trim profile, the trim profile including a bend extending in the longitudinal direction of the trim profile, wherein the bend is arranged between side edges extending in the longitudinal direction, and wherein the bend shapes an interior surface and an exterior surface of the trim profile, fixating a first part of the trim profile including the bend in a first fixation arrangement, and arranging and fixating a second part of the trim profile in a second fixation arrangement. A deep drawing operation providing a relative displacement between a stamping tool and at least one of the fixation arrangements in a direction transverse to the longitudinal direction so that the stamping tool moves into a working space, wherein the deep drawing operation forces a wall material of the trim profile into the working space to provide an end wall part on the trim profile.

The present disclosure relates to a method of providing an end wall part on an elongated metal trim profile, and a trim profile of a metal sheet material

### BACKGROUND

Providing end walls, also known as end caps, on elongated metal profiles such as decorative metal trim profiles for vehicles such as cars or trucks, or at vessels such as boats, may be provided in different ways. Such metal trim profiles may generally e.g. be provided around e.g. the windows of the vehicle or vessel in order to provide a decorative finish of the transition between a body part of the vehicle or vessel and the window.

In some solutions, a plastic end part is provided and attached to the end of the trim profile, and the plastic end part hence provides the end wall on the trim profile.

Though, for e.g. aesthetic reasons, it may be desired to provide the end wall by means of the trim profile material. This may e.g. be provided by means of a bending process. According to some solutions, an aluminium trim profile may be bended at the area where the end cap is to be provided. Here, the aluminium trim profile has a relatively high sheet thickness that allows for a subsequent finishing where a relatively large amount of material may be removed at areas with unevenness or wrinkles by grinding or polishing, without penetrating the material, in order to obtain a smooth exterior surface.

A solution for providing an end wall on a metal trim profile by means of a bending process is disclosed in patent document US 2019/0151930 A1. Here a sharp edge is provided by first providing a bending operation where the metal trim material is placed between a die and a “holding-down member”, and an end part of the trim material is then bended by a stamp by displacing the stamp in a bending direction.

Then a “counter push” is provided in a further processing step where a further stamp with a step design is moved in the direction opposite to the bending direction. Another solution for providing an end wall on a metal trim profile by means of a bending process is disclosed in patent document DE 10 2014 108 726 A1. Here a bending operation is provided, also by means of a stamp, and this is provided in a way so that the wall material becomes thinner in the bending area. A further stamping operation is provided in a subsequent step, after the bending, where a narrow stamping part is moved in an interior channel in a support part in order to push the corner area of the bend outwards.

However, problems still exists when providing an end wall/end cap on metal trim profiles where a part of the trim material is used for shaping the end wall/end cap.

The present disclosure provides a solution for providing end walls/end caps on elongated metal trims such as decorative metal trims for e.g. vehicles, vessels or other purposes. The metal trims may be made from a harder metal such as steel.

Additionally or alternatively, the present disclosure provides a solution for providing aesthetically desirable end walls/end caps on a metal trim made from a thin metal material such as a steel material. Additionally or alternatively, the present disclosure provides a solution for providing aesthetically desirable end walls/end caps on a metal trim in a faster and/or more cost efficient way.

### SUMMARY

The present disclosure relates in a first aspect to a method of providing an end wall part on an elongated metal trim profile. The method comprises:
providing an elongated trim profile of a metal plate material, the trim profile comprising one or more bends extending in the longitudinal direction of the trim profile, wherein said one or more bends are arranged between side edges extending in the longitudinal direction of the trim profile, and wherein the one or more bends shapes an interior surface and an exterior surface of the trim profile, arranging and fixating a first part the trim profile comprising said one or more bends in a first fixation arrangement, and arranging and fixating a second part of the trim profile in a second fixation arrangement, and
providing a deep drawing operation by providing a relative displacement between a stamping tool and at least one of the fixation arrangements in a direction transverse to the longitudinal direction of the trim profile so that the stamping tool moves into a working space, wherein the deep drawing operation forces a wall material of the trim profile into the working space and thereby provides an end wall part on the trim profile.

The present disclosure provides a solution where end walls/caps may be provided in a thin metal material, such as in stainless steel, and provides a result that may need less or almost no subsequent treatment of the outer surface of the end wall part in order to provide the desired end cap design and surface smoothness. The inventor has provides several tests that where an acceptable result can be provided in e.g. thin stainless steel plate steel on trim profiles that comprises several pre-provided bends in the longitudinal direction of the trim profile.

No or a reduced amount of wrinkles or other unevenness compared to e.g. a bending solutions may be provided by the method of the present disclosure.

The deep drawing operation provides a stretching of the trim profile material, so that at least a part of the material placed between the first and second fixation arrangement is deformed and stretched and thus made thinner when the stamping tool moves into the working space.

The method may additionally or alternatively result in a manufacturing solution that provides an increased number of trim profiles that is of sufficient quality and hence result in a solution where the scrap rate can be reduced. The method may additionally or alternatively result in a manufacturing solution that provides a fast manufacturing process where the need of subsequent processing of the trim profile and especially the end wall part to obtain a solution of visually high quality after the deep drawing operation may be reduced.

Utilizing the deep drawing operation may also help to provide a low inner bending radius in the transition between the trim profile's longitudinal extent and the end wall without the need of subsequent processing to further reduce the inner bending radius to a desired radius value.

In one or more aspects of the present disclosure, the working space is provided between the first and second fixation arrangements, and wherein the working space extends in the longitudinal direction of the trim profile.

This may e.g. help to provide a good control of the deep drawing process and/or to provide a more simple mechanical solution.

In one or more aspects of the present disclosure, the working space is arranged opposite to a surface of an interior support part of the first fixation arrangement, which will face the end wall part provided during the deep drawing operation.

One or both of the fixation arrangements may be either fixed or movably arranged.

In one or more aspects of the present disclosure, the trim profile comprises a plurality of bends extending in the longitudinal direction of the trim profile, wherein the plurality of bends comprises a first bend providing an elongated crest on the exterior surface, and one or more second bends placed between the first bend and one of the side edges of the trim profile.

The one or more second bends, such as at least two second bends, may preferably provide further elongated crests/ridges on the exterior surface.

The one or more bends provides a desirable visual design of the trim profile and may furthermore help to provide that sealing systems may be fixed and held in a desired manner between the trim profile and the body part such as a car door or vehicle body part on which the final trim profile is arranged.

In one or more aspects of the present disclosure, the metal plate material of the trim profile is a steel material such as a stainless steel material, for example a chromium-nickel stainless steel material.

Steel material may provide some advantages as compared to e.g. aluminium, as the steel material may be harder and may allow for a more cost efficient solution. Stainless steel material, such as chromium-nickel stainless steel material provides increased corrosion resistance. Stainless steel is more corrosion resistant and thus, when applying a coating layer such as chrome plating, painting or the like on the trim profile to reach the desired visual end result, the trim profile with the coating may be more wear and/or weather resistant over time and the coating may be longer lasting.

In one or more aspects of the present disclosure, the steel material comprises at least 12% by weight of chrome (Cr). Such steel material may be especially corrosion resistant. In one or more aspects of the present disclosure the steel material may be a SUS 304 (Japanese Industrial Standards (JIN)) grade steel or a SUS 304L grade steel. In aspects, the steel may be a DIN EN-2-X5CrNi18-10 steel.

In one or more aspects of the present disclosure, the material of the trim profile has a wall thickness between 0.2 mm and 1.0 mm such as between 0.3 mm and 0.8 mm, preferably between 0.4 mm and 0.6 mm.

Such general steel material thicknesses may allow for desirable design options, and at the same time provide a cost efficient solution.

The method according to one or more aspects of the present disclosure allows a design of end walls of metal, such as steel, e.g. stainless steel profiles having a wall thickness between 0.2 mm and 1.0 mm such as between 0.3 mm and 0.8 mm, preferably between 0.4 mm and 0.6 mm, which can be made smooth and precise enough, by means of the deep drawing process.

The material of the trim profile may in other aspects of the present disclosure a wall thickness between 0.2 mm and 3 mm such as between 0.3 mm and 1.5 mm. This may e.g. be relevant if the trim profile material is aluminium alloy material or another material softer than stainless steel, but it may also apply for stainless steel profiles.

In one or more aspects of the present disclosure, the stamping tool may initiate the deep drawing operation by abutting and deforming a crest of the trim profile, wherein the crest is provided by the one or more bends extending in the longitudinal direction of the trim profile.

It appears by tests that by abutting and initially deforming the crest by means of the deep drawing operation may help to provide a desired shape and extent of the end wall.

Generally, the deep drawing operation may allow to provide a rather large “draw length” in order to provide an end wall having a desired surface area that may substantially correspond to or even be larger than the interior cross sectional space of the trim profile.

In one or more aspects of the present disclosure, at least one of said one or more bends may provide a first wall part and a second wall part, wherein the bend angle between the first and second wall parts is between 45° and 150°, such as between 85° and 130°, for example between 100° and 120°.

The present disclosure allow for providing end walls on trim profiles that have wall parts providing a bend angle between the wall part that is relatively steep. The angle between the wall two wall parts provided by the respective bend may be obtuse, substantially 90° or even acute. The wall parts may comprise a substantially straight wall part extending between two bends or a bend and an edge of the trim profile, but the wall parts may also be more or less curved between the two bends or a bend and edge of the profile. Most often though, the wall parts may be less curved than the bends.

In one or more aspects of the present disclosure, said method further comprises providing a cut out operation prior to the deep drawing operation, wherein the cut out operation comprises providing a cut out at the one or more second bends in an end wall area in order to remove at least a part of the trim profile material at the one or more second bends.

This may help to provide an end wall part with a smoother surface and/or less wrinkles or bulges after the deep drawing process and prior to the finishing of the end wall. The end wall area is in the area of the trim profile where the deep drawing is provided in order to provide and shape the end wall part. In one or more aspects of the present disclosure, the trim profile has a width and a height, wherein said provided cut out has a length which is between 0.2 and 3 times, such as between 0.5 and 1.5 times the height of the trim profile. In one or more aspects of the present disclosure, the cut out has a length which is at least 0.5 times, such as at least 1.5 times the height of the trim profile.

In one or more further aspects, the said cut out may extend into the first and/or second wall part.

In one or more aspects of the present disclosure, the first fixation arrangement provides a more firm fixation of the material of the trim profile held by the first fixation arrangement, compared to the fixation of the trim profile provided by the second fixation arrangement.

This may help to allow material to be supplied towards the first fixation arrangement in the working space during the deep drawing operation.

In one or more aspects of the present disclosure, the first fixation arrangement strictly fixates the material of the trim profile so as to substantially prevent the material of the trim profile held by the first fixation arrangement from sliding into the working space during the deep drawing operation.

This may provide a sufficient control and precision when providing the end wall.

In one or more aspects of the present disclosure, the second fixation arrangement may be configured, such as controlled, adjusted and/or displaced, so as to provide a supply of trim profile material at the second part of the trim profile towards the first fixation arrangement during the deep drawing process. This may all help to reduce the overall stretching of the trim profile material and provide more material for the end wall part.

This may e.g. in further aspects be obtained by actively or passively moving/displacing the second fixation arrangement towards the first fixation arrangement during the deep drawing process, allow the material of the second part of the trim profile to slide between the fixation parts of the second fixation arrangement during the deep drawing operation and/or moving/displacing the second fixation arrangement in the same movement direction as the stamping tool during the deep drawing operation.

In one or more aspects, the second fixation arrangement may be configured so as to allow the trim profile material at the second part of the trim profile to slide towards the first fixation arrangement during the deep drawing process.

In one or more aspects, a relative displacement during the deep drawing operation in order to bring the stamping tool into the working space and deform the trim profile to provide the end wall part is provided by keeping the first and second fixation arrangements in a fixed position and moving the stamping tool into the working space.

In one or more aspects of the present disclosure, the first fixation arrangement comprises a first set of support parts, wherein the first set of support parts comprises
an interior support part arranged in an interior space of the trim profile, wherein the interior support part comprises a support surface shaped to follow and support the interior surface of the trim profile, and
an exterior support part at the exterior surface, wherein the exterior support part comprises a support surface shaped to follow and support on the exterior surface of the trim profile, wherein the first part of the trim profile is arranged and held between the interior support part and the exterior support part during the deep drawing operation.

Such fixation arrangement may be advantageous to use during the deep drawing operation as it may allow for an improved control of the trim profile during the deep drawing process.

In one or more aspects of the present disclosure, the second fixation arrangement comprises a second set of support parts, wherein the second set of support parts comprises
an interior support part arranged in an interior space of the trim profile, wherein the interior support part comprises a support surface shaped to follow and support the interior surface of the trim profile, and
an exterior support part at the exterior surface, wherein the exterior support part comprises a support surface shaped to follow and support on the exterior surface of the trim profile, wherein the second part of the trim profile is arranged and held between the interior support part and the exterior support part during the deep drawing operation.

Holding the trim profile between the first and second fixation arrangements comprising the interior and exterior support parts may help to allow a sufficient and advantageous fixation of the trim profile during the deep drawing, which in the end may help to provide a trim profile with an end wall of a desired design and/or size.

In one or more aspects of the present disclosure, the interior support part of the first and/or second fixation arrangement may comprise one or more ridges extending into a recess of the interior surface of the trim profile which is shaped by one or more of said bends extending in the longitudinal direction of the trim profile, and wherein the trim profile material at the one or more bends supports on the one or more ridges of the interior support part during the deep drawing operation. This may e.g. allow for an improved support of the trim profile and may help to avoid or reduce unintentional/undesired bends or bulges on parts of the trim profile that is used for the final trim. Also the adapted shape of the interior support part helps to maintain the initial shape (caused by the one or more bends) of the relevant part (such as the first part) of the trim profile during the deep drawing operation.

In one or more aspects of the present disclosure, the exterior support part may comprise one or more recesses in the support surface into which a crest of the trim profile extends during the deep drawing operation, wherein the crest is a crest provided by one or more of said bends.

Also this may further allow for a sufficient support of the trim profile in order to avoid or reduce unintentional/undesired bends or bulges on parts of the trim profile that is used for the final trim and help maintaining the initial shape (caused by the one or more bends) of the trim profile where the first and/or second fixation arrangement holds the trim profile.

The interior support part(s) may hence comprise a convex surface, which fits into the concave surface of the interior surface of the trim profile shaped by the bend(s) in the longitudinal direction of the trim profile, whereas the exterior support part(s) may comprise a concave support surface facing and supporting on the exterior surface of the trim profile. The support surfaces of the exterior and interior support parts hence fits the shape of the trim profile and accordingly provides a good support during the deep drawing operation in order to reduce undesired wrinkles and/or unevenness in the finalized trim profile.

In one or more aspects of the present disclosure, at least the first interior support part comprises a corner support portion having a corner shape configured to define the interior bending radius at the corner at the transition between the trim profile and the end wall part on the trim profile when the deep drawing operation is provided.

This may e.g. help to provide that the end wall corner in the transition between the side walls extending in the longitudinal direction of the trim profile, and the end wall comprises the desired shape and/or interior radius.

In one or more aspects of the present disclosure, the bends of the trim profile provides elongated wall parts extending in the longitudinal direction of the trim profile, said elongated wall parts comprising a first wall part extending between a first bend and a second bend, a second wall part arranged between said first bend and the other side edge of the trim profile, and a third wall part extending between the second bend and a first side edge. For example such a trim profile has a shape at which the deep drawing process according to the present disclosure may provide a deep drawing operation on to shape an end wall part, and this may be an end wall part where the draw length may have a sufficient draw length to at least cover an interior space in the trim profile. In one or more further aspects, a fourth wall part may also extend between said other side edge and a further second bend, wherein the further second bend is arranged between the first bend and said other side edge.

In one or more aspects of the present disclosure, the previously mentioned cut out provides that the third wall part and/or fourth wall part is removed, such as substantially entirely removed, in the area of the cut out.

This may help to provide space for inserting an internal support part and/or help to provide a desired weakening of the profile at certain locations before the deep drawing, in order to avoid or reduce undesired wrinkles or bulges on the trim profile due to the deep drawing.

In one or more aspects of the present disclosure, the trim profile has a width and a height wherein the width and/or the height is between 2 mm and 50 mm, such as between 3 mm and 20 mm, such as between 4 mm and 15 mm. The length of the trim profile (i.e. in the longitudinal direction) may be at least twice, such as at least five times or at least ten times the width and/or length.

In one or more aspects of the present disclosure, the trim profile may have a C-shape in cross section, where the C-shape is provided by a first bend and further bends extending in the longitudinal direction of the trim profile. Such profiles may provide some advantages with regard to holding or supporting certain components such as e.g. elongated seals, e.g. rubber seals while at the same time provide a trim profile with a desired visual design and shape. The C shape may be rounded or provided by more straight wall parts extending from said one or more bends that extends in the longitudinal direction.

In one or more aspects of the present disclosure, wall parts are removed at a position of the trim profile at the first part, proximate the end wall on the part of the trim profile that is used for the finalized trim profile, wherein said wall parts provides an entrance and/or exit area for an interior support part of the first and/or second fixation arrangement. It may be difficult to remove an interior support part after the end wall has been provided, though the area with the removed wall parts may enable or make such removal or entering of the interior support part easier.

In one or more aspects of the present disclosure, the inner bending radius at the end wall which is provided due to the deep drawing operation is below 2 mm, such as below 1 mm, for example below 0.8 mm.

The inner bending radius in the bend in the transition between the elongated profile and the end wall which is provided due to the deep drawing may e.g. in aspects of the present disclosure be between 0.2 mm and 3 mm, such as between 0.4 mm and 2 mm, e.g. between 0.6 mm and 2 mm.

In one or more aspects of the present disclosure, a control system controls a driver device, such as an electric driver device, such as a servo motor or a stepper motor, and wherein the driver device displaces the stamping tool into said working space from an initial position to an end position in order to provide the deep drawing operation. This may e.g. be provided by means of the motor operating a spindle such as a spindle drive connecting the motor and the stamping tool. The driver device may preferably an electrically driven driver device.

Such a driver device may enhance control of the deep drawing operation. Especially an electric servo motor or an electric stepper motor may be advantageous as such a driver device may improve control with the deep drawing operation and hence the result of the deep drawing operation.

In one or more aspects of the present disclosure, the displacement speed of the stamping tool is varied during the deep drawing operation between an initial position where the deep drawing operation is initiated and the end position where the deep drawing operation is ended. The present inventor has seen indications during tests that varying the displacement speed of the stamping tool may help to provide an end wall part that may comprise less wrinkles and/or help to provide that the draw length may be increased.

In one or more aspects of the present disclosure, the displacement speed of the stamping tool reduced, such as gradually reduced, during the deep drawing operation. Reducing the displacement speed of the stamping tool during the deep drawing operation may help to avoid damaging the trim profile material and/or help to provide that the draw length may be increased.

In one or more aspects of the present disclosure, the displacement speed of the stamping tool is controlled by a control system according to a displacement speed profile stored in a data storage. This may e.g. help to assure controlled operation and/or more consistent end results in an automated way.

In one or more aspects of the present disclosure, a further calibration of the end wall part is provided subsequent to the deep drawing operation, such as by means of a processing device such as a roller rotating and supporting on the end wall part, in order to process the exterior surface of the end wall part. This may help to provide an end wall with the desired surface smoothness and/or shape. In further aspects of the present disclosure, a cutting and/or grinding operation is provided subsequent to the deep drawing operation in order to remove excess material from the deep drawing operation and separate the end wall part from the excess material.

In one or more aspects of the present disclosure, the one or more bends extending in the longitudinal direction provides an interior space in the elongated profile, wherein at least two, such as at least three, for example at least four walls of the trim profile extending in the longitudinal direction encloses the interior space, wherein the cross sectional area of the interior space determined between said walls and enclosed by an envisaged bottom line drawn between the side edges of the profile extending in the longitudinal direction is between 0.5 cm² and 5 cm², such as between 1 cm² and 4 cm².

In one or more aspects of the present disclosure, the deep drawing operation provides a draw length by means of the stamping tool, wherein the draw length is at least 5 mm, such as at least 9 mm, for example at least 13 mm. The draw length may be determined by the largest draw length provided at the trim profile in order to deform the trim profile at the part and thereby obtain the end cap/end wall part.

Generally, the draw length provided by the deep drawing operation in order to obtain the end wall should preferably provide that the end wall part is large enough to cover the interior space at the end of the profile, and may moreover in further aspects have an area that is larger than the cross sectional area of the interior space.

In one or more aspects of the present disclosure, the deep drawing operation provides that the end wall thickness of an area of the end wall is reduced by at least 10%, such as at least 20%, for example at least 30% when compared to the general material thickness of the trim profile. The general material thickness is the initial wall thickness of the trim profile. E.g. if the final trim profile has been made from a metal material such as steel having a material thickness of 0.5 mm, the general material thickness of the trim profile is 0.5 mm. In embodiments of the present disclosure, the thickness of the wall at the end wall may be reduced by between 15% and 40% due to the deep drawing operation.

In one or more aspects of the present disclosure, the corner radius at the transition between the stamping surface of the stamping tool and the end surface of the stamping tool is larger than 5 mm such as larger than 10 mm, or even larger such as larger than 15 mm. This may help to allow more end wall material to be “supplied” for the end wall during the deep drawing operation, and may help to assure that the end wall does not get too thin as the wall material may more easily slide over the corner during the deep drawing.

According to a second aspect, the present disclosure relates to an elongated trim profile of a metal sheet material, wherein the trim profile comprising a plurality of bends extending in the longitudinal direction of the trim profile, wherein said plurality of bends are arranged between side edges extending in the longitudinal direction of the trim profile, and wherein the one or more bends shapes an interior surface and an exterior surface of the trim profile, wherein the elongated trim profile comprises an end wall shaped in the material of the elongated trim profile, wherein the end wall has been provided as a result of a deep drawing operation and consequently comprises an area at the end wall which has a reduced wall thickness compared to the general wall material thickness of the trim profile.

In one or more aspects of the second aspect, the wall thickness of said area of the end wall with the reduced wall thickness is at least 10%, such as at least 20%, for example at least 30% lower than the general material thickness of the trim profile.

In one or more aspects of the second aspect, the general material thickness of the trim profile is between 0.2 mm and 1.0 mm such as between 0.3 mm and 0.8 mm, preferably between 0.4 mm and 0.6 mm.

In one or more aspects of the second aspect, the trim profile comprises a plurality of bends extending in the longitudinal direction of the trim profile, wherein the plurality of bends comprises a first bend providing an elongated crest, and one or more second bends placed between the first bend and one of the side edges of the trim profile.

In one or more aspects of the second aspect, the metal plate material of the trim profile is a steel material such as a stainless steel material, for example a chromium-nickel stainless steel material. The steel material may e.g. in aspects of the second aspect comprise at least 12% by weight of chrome.

In one or more aspects of the second aspect, the trim profile has a width and a height wherein the width and/or the height is between 2 mm and 50 mm, such as between 3 mm and 20 mm, such as between 4 mm and 15 mm.

In one or more aspects of the second aspect, the trim profile has a C-shape in cross section, such as wherein the C-shape is provided by a first bend and further second bends extending in the longitudinal direction of the trim profile.

In one or more aspects of the second aspect, the inner bending radius at the end wall which is provided due to the deep drawing operation is below 3 mm, such as below 2 mm, for example below 1.5 mm.

In one or more aspects of the second aspect, at least one of said bends provides a first wall part and a second wall part, wherein the bend angle between the first and second wall parts is between 45° and 150°, such as between 85° and 130°, for example between 100° and 120°.

In one or more aspects of the second aspect, the bends extending in the longitudinal direction provides an interior space in the elongated profile, wherein at least two, such as at least three, for example at least four walls of the trim profile extending in the longitudinal direction encloses the interior space, such as wherein the cross sectional area of the interior space determined between said walls and enclosed by an envisaged bottom line drawn between the side edges of the trim profile, which side edges extends in the longitudinal direction is between 0.5 cm² and 5 cm², such as between 1 cm² and 4 cm².

In one or more aspects of the second aspect, the area with reduced thickness on the end wall is located at a centre portion of the end wall located between an edge of the end wall and the bend providing the transition between the end wall and the part of the trim profile extending in the longitudinal direction.

In one or more aspects of the second aspect, the end wall is provided by means of a method according to any of items 1-56, any of claims 1-48 and/or by means of a method according to one or more of the above or below mentioned aspects of the first aspect.

The present disclosure additionally, in a third aspect, relates to an elongated trim profile (1) with an end wall (30) provided by means of a method according to any of items 1-56, any of claims 1-48 and/or by means of a method according to one or more of the above or below mentioned aspects of the first aspect.

In one or more aspects of the present disclosure, during the deep drawing operation, the first fixation arrangement is providing a tight hold on the first part of the trim profile, such that the first part of the trim profile is fixed with respect to the first fixation arrangement and the second fixation arrangement is providing hold on the second part of the trim profile, which is weaker that the tight hold on the first part, such that the second part of the trim profile is movable relative to the fixation arrangement. During the deep drawing operation, trim profile material may then be fed from the second fixation arrangement to the work space, e.g. the trim profile may be allowed to slide in the second fixation arrangement and in a direction towards the first fixation arrangement, while the trim profile material held by the first fixation arrangement is stationary with respect thereto. Preferably, this allows for the trim profile material to undergo a general flow towards the first fixation arrangement during the deep drawing process, while simultaneously allowing for the material within the work space to be stretched and made thinner, e.g. from 1 mm to between 0.5 and 0.9 mm. Alternatively or additionally, the second fixation arrangement may be displaceable towards the first fixation arrangement during the deep drawing operation in order to feed material.

Advantageously, a final product of desired appearance, such as smoothness, and structural properties has in particular been realised by the present setup, even though the trim profile material will have to undergo a lot of work by flowing across a large distance from the second fixation arrangement, around the stamping tool and to the first fixation arrangement.

Additionally, both fixation arrangements may preferably be substantially stationary during the deep drawing operation while the stamping tool is displaced into the work space.

Advantageously, this lessens the requirements on the holding strength of the fixation arrangements and further decreases the complexity of the setup, as only the stamping tool needs to be movable during the deep drawing process.

In one or more aspects of the present disclosure, the material of the trim profile has a wall thickness of less than 1 mm. The end wall provided by the present aspects may comprise a general wall thickness of at least 0.5 mm, such as between 0.5 and 1 mm. The general wall thickness of the end wall may though be lower than the wall thickness of the remaining part of the trim profile.

In one or more aspects of the present disclosure, the interior support part of the first set of support parts of the first fixation arrangement and/or interior support part of the second set of support parts of the second fixation arrangement comprise a plurality of support elements, which are movable relative to each other such that a collective width of the interior support part is changeable between a narrow and wide configuration. The support elements may preferably be discrete and separate to one another.

The width of the interior support part may be changeable and selective in that the interior support part can be arranged with a width, which is larger in a locked state than in an unlocked state, such that the locked state allows for fixation by engagement of the support elements with the wall parts of the trim profile, and such that the unlocked state allows for the trim profile to be released by disengagement of the support elements with the wall parts. The width of the interior support part may be provided by the collective width of the discrete support elements and may be measured transverse to the longitudinal extent of the interior support part, which is substantially parallel to the longitudinal extent of the trim profile, when the trim profile is arranged in a state thereon.

The locked and unlocked state of the discrete support elements may be provided by arranging each discrete support element to be movable relative to each other. One or more, and preferably all discrete support elements are arranged to be movable into the unlocked stated by moving the discrete support elements away from the interior surface of the trim profile. However, the discrete support elements may be moved along different directions from the trim profile, e.g. the interior support part may comprise a first support element arranged to be movable in a direction towards and away from the first bend of the trim profile, a second and third element each arranged to be movable in a direction towards and away from a second bend and/or the walls extending between the first and second bend. The second and third elements may be arranged on each side of the first element.

In one or more aspects, the support elements are each arranged to support an interior surface of the trim profile during the deep drawing process, preferably by abutting a part of said interior surface of the trim profile, such as substantially the entire interior surface of the trim profile. Collectively, the support elements may provide a support surface shape corresponding to the interior surface curvature of the interior surface of the trim profile, when supporting the trim profile.

In one or more aspects, in the unlocked state, at least a part of the collective support surface can be disengaged from the trim profile by sliding and/or lifting the trim profile from the interior support part in a direction along or transverse to the longitudinal extent of the trim profile, respectively. E.g., the discrete support elements may be displaced so far away from the interior surface of the trim profile, that sufficient space is provided between the edges of the trim profile and the discrete support elements that the trim surface can pass the interior support part by lifting. Alternatively or additionally, the unlocked state provides sufficient space between the interior surface of the trim profile and the support surface of the interior support part, that it eases displacement along a longitudinal extent of the trim profile upon demounting.

In one or more aspects, the trim profile may be moved while the fixation arrangement is stationary, or vice versa, when demounting and mounting the trim profile in the fixing arrangement.

Advantageously, by the movable support elements, a tight fit of the trim profile on the interior support part may be provided in the locked state, increasing the fixation strength and decreasing the risk of damaging the trim profile during the manufacture of the end wall. As a further advantage, the movable support elements allow for the trim profile to be more readily de mounted from the interior support surface e.g. by sliding or lifting the trim profile onto the interior support surface along a longitudinal extent thereof.

In one or more aspects of the present disclosure, the cutting and/or grinding operation is provided as a post-cutting operation, subsequent to the deep drawing operation in order to remove excess material from the deep drawing operation and separate the end wall part from the excess material. The post-cutting operation may be provided in the second part of the trim profile, preferably in the end wall part extending between the corner located at the transition between the first part of the trim profile and the end wall part and the corner located in the second part and provided by the corner arranged between the end surface of the stamping tool facing the end wall part and the stamping surface of the stamping tool. The post-cutting operation is preferably provided so that the end wall part is provided with an extent terminated prior to the corner provided by the corner of the stamping tool, located between the stamping surface and the end surface of the stamping tool facing the end wall part. Consequently, the end wall part provided is generally of a planar extent, preferably arranged by majority along a vertical and perpendicular to the longitudinal extent of the trim profile. However, the end wall part may be arranged at an angle relative to the longitudinal extent of the trim profile. The cut-off edges may hereafter be shaped, grinded or polished or otherwise post-treated, for example to provide an aesthetically pleasing appearance, if needed.

Advantageously, an end wall part may thereby be provided, closing off the interior space of trim profile in a longitudinal direction thereof and simultaneously terminating the longitudinal extent of the trim profile.

In one or more aspects of the present disclosure, the method comprises the step of: providing a pre-cutting operation prior to the deep-drawing operation and/or a post-cutting operation after the deep-drawing operation, wherein the pre-cutting operation and/or the post-cutting operation is provided by means of one or more laser systems.

A fourth aspects of the present disclosure relates to a method of providing an end wall part on an elongated metal trim profile, the method comprising:

providing an elongated trim profile of a metal plate material, the trim profile comprising one or more bends extending in the longitudinal direction of the trim profile, wherein said one or more bends are arranged between side edges extending in the longitudinal direction of the trim profile, and wherein the one or more bends shapes an interior surface and an exterior surface of the trim profile, arranging and fixating a first part of the trim profile comprising said one or more bends in a first fixation arrangement, and arranging and fixating a second part of the trim profile in a second fixation arrangement, and providing an end wall forming operation, such as by bending and/or deep drawing the trim profile in a direction transverse to the longitudinal direction of the trim profile so that a wall material of the trim profile provides an end wall part on the trim profile, and providing a pre-cutting operation prior to the end wall forming operation and/or a post-cutting operation after the end wall forming operation, wherein the pre-cutting operation and/or the post-cutting operation is provided by means of one or more laser systems.

Advantageously, by employing a laser system for executing the cutting operation in one or more aspects of the present disclosure, allows for quick and precise cutting operation and potentially large reproducibility of the finished product.

The method may employ several laser system, e.g. one for each cutting operation and which may advantageously be provided in separate locations. Alternatively, the same laser system may be used for all cutting operations of the method, thereby reducing the overall cost of the manufacturing system, however potentially increasing the complexity of the setup. Preferably, the post-cutting operation provided as finalised trim profile with an end wall.

In one or more aspects of the fourth aspect, the end wall part forming operation may comprise any suitable metal forming operations, such as one or more of the following operations for forming and end wall part: deep-drawing operation, press-braking and/or roll-forming etc.

In one or more aspects of the present disclosure, the method may comprise the step of:
providing a pre-cutting operation and/or a post-cutting operation by means of one or more laser systems, wherein the pre-cutting operation is provided in order to provide a cut out and/or a further cut out prior to the deep-drawing operation,
   wherein the cut out is provided at the second bend(s) in the end wall area of the second part in order to remove at least a part of the trim profile material at the one or more second bends, and
   wherein the further cut out is provided in the first part proximate the end wall area in order to remove at least a part of the wall material of the wall parts, and
   wherein the post-cutting operation is provided at the end wall part in order to remove excess material and so as to separate the end wall part from excess material subsequent to the deep-drawing operation.

In one or more aspects, the pre-cutting operation comprises the method step of providing the cut out as described according to any of the previous aspects of the present disclosure. Additionally or alternatively, the pre-cutting operation comprises the method step of providing the further cut out as described according to any of the previous aspects of the present disclosure.

In one or more aspects, the further cut out do not extend into the first and/or second wall part. Preferably, this allows for a visually appealing finish of the trim profile having continuous wall parts between the first and second bends, which typically constitute the walls being visible after instalment of the trim profile. The trim profile may preferably be arranged to be used externally on a vehicle.

In one or more aspects, the further cut out is extending to a line providing the border between the first and second parts of the trim profile. Consequently, material present abutting the border between the first and second parts may be removed in order to allow a larger flow control during bend forming at the boarder and during the deep drawing operation, or other end wall forming operations. Preferably, only parts of the wall parts extending from the second bends to the edges of the trim profile is provided with the further cut out, such that the wall parts between the first bend and the second bends are devoid of any cut outs.

In one or more aspects, the one or more laser systems each comprises a laser source providing a laser beam for cutting in said trim profile, wherein the laser source may be provided by a fiber laser, such as fiber laser utilizing nitrogen or argon as assist gas. A fiber laser is a laser, which utilizes an optical fiber doped with rare-earth elements as active gain medium.

The fiber laser may be utilizing any inert gas as assist gas, e.g. helium or oxygen, however preferably argon or nitrogen gas. The assist gas may be used to blow away molten material, thereby provide a cleaner cut and also protect the laser system from material splatter. Additionally, the use of the right assist gas may increase cutting speed. In one or more aspects, the fiber laser may comprise a power rating of up to 4 kW. In one or more aspects, the fiber laser may additionally be provided with water cooling and/or purge gas of clean dry air.

In one or more aspects, the fiber laser may be arranged to be fitted on a robot, e.g. via a robot mount. The fiber laser may be movably arranged so that the fiber laser may be movable relative to the robot, e.g. by employing a robot mount allowing for rotational and/or linear movements relative to the robot.

In one or more aspects, the fiber laser comprises a laser controller, which may comprise a computer processor and a data storage with a program code including pre-determined laser settings for the cutting operation. The laser controller may be arranged to control the fiber laser according to the predetermined settings. The laser controller may include communication means for providing output and receiving input to and from a user or device, e.g. a user interface. The communication means may be arranged to provide data relating to the fiber operation, such as fiber laser condition, to a display and/or data storage.

Alternatively, other laser sources than a fiber laser may be employed. Preferably, the laser source is of a laser power capable of providing accurate through holes in 1 mm metal profiles, such as steel profiles.

In one or more aspects, at least one of the laser systems is mounted on an industrial robot, and wherein the industrial robot is arranged to automatically control the pre-and/or post-cutting operation provided by the laser source according to pre-determined settings, such as according to a predefined program code stored in a data storage. The predefined program code may be stored in an externally or internally located data storage of the robot. The predefined program code may be a part of robot control software configured for motion control, development and execution of program codes, and/or communication etc.

In one or more aspects, a control system may be used in the method, the control system may comprise a computer processor and a data storage with a program code, which may e.g. contain predetermined settings. The control system may be arranged to control the industrial robot according to the predetermined settings. The control system may be comprised in the robot or externally located.

In one or more aspects, the robot may also be equipped with communication means, e.g. including a communication interface, for communication to and from the control system and/or the user of the robot.

In one or more aspects, the control system comprises the laser controller, and is arranged to execute a cutting operation provided by a combination of pre-determined settings for both the industrial robot and the fiber laser. An automated execution of a cutting operation, such as a sequence of cutting operations, may thereby be provided by a collaboration of the robot and the fiber laser.

Advantageously, by employing and industrial robot, the method may be executed in a quicker, more precise and thereby more efficient manner. Additionally, the industrial robot may be readily adjustable allowing for quick implementation of any modifications to the method and the finished product. Employing an industrial robot allows for robot based automation of at least a part of the method according to the invention. Additionally or alternatively, in one or more aspects, the industrial robot may be manually controlled.

In one or more aspects, the industrial robot is arranged to provide movement about a plurality of axes, preferably about six axes. Preferably, the arms of the robot may allow for tilting, bending, rotation etc., such that the laser beam can access various sides of the trim profile, without having to move the trim profile. Advantageously, the cutting operation may be executed by a single laser system mounted on a single robot.

In one or more aspects, the industrial robot is movable by base rotation motion and base arm motion at the lowermost part of the robot, middle arm motion and middle wrist motion at a middle part of the robot, and tip bend motion and tip turn motion at a top part of the robot, thereby providing a large working range of the robot. In one or more aspects, the robot may be configured to be able to undergo one or more, preferably all, of the following motion characteristics: base rotation motion from +170° to −170° degrees, base arm motion from +130° to −100°, middle arm motion from +70° to −200°, middle wrist motion from +270° to −270°, top bend motion from +130° to −130° and top turn motion from +400° to −400° with maximum revolution +1-242°.

In one or more aspects, the industrial robot is arranged to provide a pose repeatability down to 0.020 mm, such as down to 0.025 mm. The ability of the robot in achieving repeatability in robot configuration in terms of linear and angular position in turn provides cutting operations of high repeatability of the trim profiles produced. Repeatability may be defined as the closeness of agreement between several positions reached by the industrial robot's end-effector, e.g. where the laser is located, for the same controlled position, repeated several times under the same conditions. Geometrically, the position repeatability can be defined as the radius of the smallest sphere that encompasses all the positions reached for the same requested position.

In one or more aspects, the industrial robot is arranged to provide a pose accuracy of down to 0.02 mm, wherein pose is defined as the robot configuration in terms of linear and angular position. High accuracy is of particular importance for automated robot based cut-out operations executed by the robot. The accuracy is the deviation between a command task and the attained task actually executed by the robot, or the precision with which a calculated robot pose can be achieved.

In one or more aspects, the industrial robot is arranged to provide linear path repeatability down to 0.07 mm, such as down to 0.02 mm. In one or more aspects, the industrial robot is arranged to provide linear path accuracy down to 0.77 mm, such as down to 0.53 mm.

Minimizing deviations in the position of the cutting operation in the trim profiles can have a large effect on the result of the end wall forming operation, such as the deep drawing operation, where the trim profile is formed in areas or near areas of the cut-outs. Consequently, a large precision and reproducibility of the laser is advantage, in order to produce a large reproducibility in the structural and visual properties of the finished product.

In one or more aspects, the method comprises the following sequence of steps:
providing a pre-cutting operation by means of the laser system in order to provide a cut-out and/or a further cut-out,
arranging and fixating the first part and the second part,
providing an end wall forming operation, preferably a deep-drawing operation, and subsequently
providing a post-cutting operation by means of the laser system in order to remove excess material from the end wall part.

In one or more aspects, in the step of providing a post-cutting operation by means of the laser system, excess material of the second end is fixed in position by means of a third fixation arrangement. The second fixation arrangement may in some aspects, constitute the third fixation arrangement as well. However, preferably, the third fixation arrangement is a separate fixation arrangement, arranged to sufficiently hold the excess material, which is to be cut away, while performing the post-cutting operation. Advantageously, this prevents excess material parts separated from the trim profile during the post-cutting operation from interfering with the beam of the laser source during the operation, and thereby potentially compromising the end result. In one or more aspects, the third fixation arrangement may comprise any of the features, e.g. interior and exterior support part, according to the first and/or second fixation arrangement. In one or more aspects, a calibration operation according to the present disclosure may be provided subsequent to the post-cutting operation.

In one or more aspects, the method comprises providing one or more work stations, wherein each work station is arranged to perform at least one operation according to the method, such as a pre-cutting operation, a post-cutting operation, e.g. a cutting and/or grinding operation, a deep-drawing operation and/or a calibration operation.

By separating at least a part of the method steps to be performed at different physical locations, allows for a more simplified setup at each work station potentially allowing for easy access and visibility to the operation performed. Preferably, arranging and fixation the first and second end is performed at the same station at which the deep-drawing operation is executed. The work station may all be arranged in the same manufacturing facility or at different manufacturing facilities.

In one or more aspects, the pre-cutting operation and the post-cutting operation is provided at two separate work stations. Alternatively, all cutting operations may be performed at the same working station, i.e. the trim profile may return to a previous cutting station in order to undergo further cut outs. However, by having the pre-cutting and the post-cutting operations executed at different work station, at different physical locations, allows for highly directional flow in the production line and for consecutive production of a plurality of trim profiles. Thus, higher turnout yield and efficiency can be provided.

In one or more aspects, the pre-cutting operation is performed at a first working station, the fixating and deep drawing operation is performed at a second work station and the post-cutting operation is performed at a third work station. By separation of the operations into different physical locations allows for minimizing the time spend by the trim profile at each work station and thereby optimizes the yield and decreases production time. In one or more aspects, a different end wall forming operation is executed instead of the deep drawing operation, such as a traditional bending operation.

In one or more aspects, the industrial robot is movably mounted on a displacement system, such as a rail system, so that the industrial robot may be moved to one or more work stations and provide said pre-cutting and post-cutting operation, such as at the first work station and third work station. The displacement system may comprise a rail system, a conveyor belt, and/or wheels etc. for displacement of the industrial robot.

In one or more aspects, the trim profile is movably mounted on a conveyor system providing the trim profile to be moved to one or more work stations.

Advantageously, this significantly decreases the amount of manual labour needed in the production process and further enables precise placement of the trim profile at each work station with high reproducibility. In one or more aspects, the conveyor system comprises conveyor means such as rails, wheels, conveyor belt etc. In one or more aspects, the conveyor system comprises one or more conveyor belts, preferably at least two.

In one or more embodiments, the conveyor system may comprise vertical displacement means for lifting and lowering the trim profile along the first direction. Advantageously, the position of the trim profile, and in particular the end parts, may be readily controlled, e.g. the conveyor system may thereby lower the trim profile into the fixation arrangement(s) and lift the trim profiles therefrom.

In one or more aspects, the conveyor system comprises holding means for supporting the trim profile and preventing it from falling off the conveyor system while being displaced thereby. The holding means may comprise any of the features of the first, second and/or third fixation arrangement for fixing the trim profile, such as an interior support surface of a contour similar to the interior surface curvature of the trim profile. In one or more embodiments, the holding means may comprise clamping means for retaining the trim profile in the holding means. The clamping means may be arranged to abut an exterior surface of the trim profile and provide a holding pressure towards the interior support surface of the holding means.

In one or more aspects, the method further comprises providing pre-determined settings including control commands for executing one or more method steps of the method, and wherein the method is automatically executed according to the pre-determined settings. The pre-determined setting may include a sequence of method steps according to the present disclosure, wherein control command(s) are provided to means for executing the respective method steps, e.g. operations, which means in turn execute the method step(s) in response to said command(s). The means may e.g. be the fixation arrangement(s), the stomping tool, laser system etc. The pre-determined settings may thereby provide an automatic manufacturing method, reducing the need for manual work and production time and increasing the reproducibility of the final product.

In one or more aspects, the pre-determined setting includes control commands for automatically executing at least the following operations of the method: the pre-cutting operation by means of one or more laser systems, the fixation of the first end and second end and the deep drawing operation.

In one or more aspects, the pre-determined setting further provides control commands to the rail system and/or the conveyor system, so as to automatically transfer the trim profile between work stations.

In one or more aspects, the pre-determined settings provides an automatic execution of the method from the pre-cutting to the post-cutting operation of the method, e.g. the trim profile is first placed on the conveyor belt at a first end, from here is it automatically transferred along the conveyor belt and through the different work stations, and after post-cutting, the finished trim profile may be removed. Simultaneously, the sequence of control commands of the pre-determined settings preferably also include control commands to the one or more laser systems, and optionally also to industrial robot(s) on which the laser system(s) is/are mounted and optionally also to a rail system carrying and displacing the industrial robot and the laser system.

In one or more aspects, the method further comprises the step of providing a cutting and/or grinding operation subsequent to the end wall forming operation, such as the deep drawing operation, in order to remove excess material from the deep drawing operation and separate the end wall part from the excess material.

In one or more aspects, a different end wall forming operation is executed instead of the deep drawing operation, such as a traditional bending operation.

The fourth aspect of the present disclosure may comprise any of the features and advantages, or any combination of features, as discussed in relation to methods and elongated trim profiles of any of the aspects of the present disclosure and/or according to any of items 1-56 and/or any of claims 1-47.

A fifth aspect of the present disclosure relates to a method of providing an end wall part on an elongated metal trim profile, the method comprising:

providing an elongated trim profile of a metal plate material, the trim profile comprising one or more bends extending in the longitudinal direction of the trim profile, wherein said one or more bends are arranged between side edges extending in the longitudinal direction of the trim profile, and wherein the one or more bends shapes an interior surface and an exterior surface of the trim profile, arranging and fixating a first part of the trim profile comprising said one or more bends in a first fixation arrangement, and arranging and fixating a second part of the trim profile in a second fixation arrangement, and providing a deep drawing operation by providing a relative displacement between a stamping tool and at least one of the fixation arrangements in a direction transverse to the longitudinal direction of the trim profile so that the stamping tool moves into a working space, wherein the deep drawing operation forces a wall material of the trim profile into the working space and thereby provides an end wall part on the trim profile, and providing a cutting and/or grinding operation subsequent to the deep drawing operation in order to remove excess material from the deep drawing operation and separate the end wall part from the excess material.

By the fifth aspect, a finished product is obtained being a trim profile comprising an end wall, which may preferably be used as window trim for an automobile.

The fifth aspect of the present disclosure may comprise any of the features and advantages, or any combination of features, as discussed in relation to methods and elongated trim profiles of any of the aspects of the present disclosure and/or according to any of items 1-56 and/or any of claims 1-47.

### FIGURES

Aspects of the present disclosure will be described in the following with reference to the figures in which:

FIG. 1-la: illustrates a metal trim profile according to embodiments of the present disclosure,

FIG. 2: illustrates a metal trim profile with cut outs according to embodiments of the present disclosure,

FIG. 3: illustrates a metal trim profile in a system for providing a deep drawing according to embodiments of the present disclosure,

FIGS. 3a-3b: illustrates a fixation arrangement according to embodiments of the present disclosure,

FIG. 4: illustrates a deep drawing operation according to embodiments of the present disclosure in order to provide an end wall part,

FIGS. 4a-4b: illustrates an embodiment of a stamping tool surface according to embodiments of the present disclosure,

FIG. 5: illustrates an end wall/end cap provided at a final trim profile according to embodiments of the present disclosure,

FIG. 6: illustrates a view towards an end wall/end cap provided at a final trim profile according to a further embodiment of the present disclosure,

FIG. 7: illustrates a further embodiment of a trim profile 1 according to embodiments of the present disclosure,

FIG. 8: illustrates an embodiment of the present disclosure where an end wall part is further processed,

FIG. 9: illustrates a deep drawing operation provided by means of a control system, according to embodiments of the present disclosure,

FIGS. 10a-10e: illustrates various embodiments of displacement speed profiles,

FIG. 11: illustrates an embodiment of the present disclosure where material is supplied for a deep drawing process,

FIG. 12: illustrates a still further embodiment of the present disclosure where material is supplied for a deep drawing process,

FIG. 13: illustrates a vehicle comprising trim profiles manufactured according to embodiments the present disclosure,

FIG. 14: is a photo of an intermediate product provided by means of a deep drawing process according to embodiments of the present disclosure in order to provide an end wall/end cap,

FIG. 15: is a photo of the trim profile of FIG. 14 after excess material has been provided,

FIG. 16: is a photo of the trim profile like the one illustrated in FIG. 15 after a polishing and further processing of the end wall has been provided,

FIG. 17a-b: illustrates an embodiment of an interior support part comprising movably arranged support elements, and

FIG. 18: illustrates an embodiment of a manufacturing system for producing an end wall part on a trim profile.

### DETAILED DESCRIPTION

In relation to the figures described below, where the present disclosure may be described with reference to various embodiments, without limiting the same, it is to be understood that the disclosed embodiments are merely illustrative of the present disclosure that may be embodied in various and alternative forms. The figures may not be to scale; some features may be exaggerated or minimized to show details of particular components. Therefore, specific structural and functional details disclosed herein are not to be interpreted as limiting, but merely as a representative basis for e.g. teaching one skilled in the art to variously employ the present disclosure.

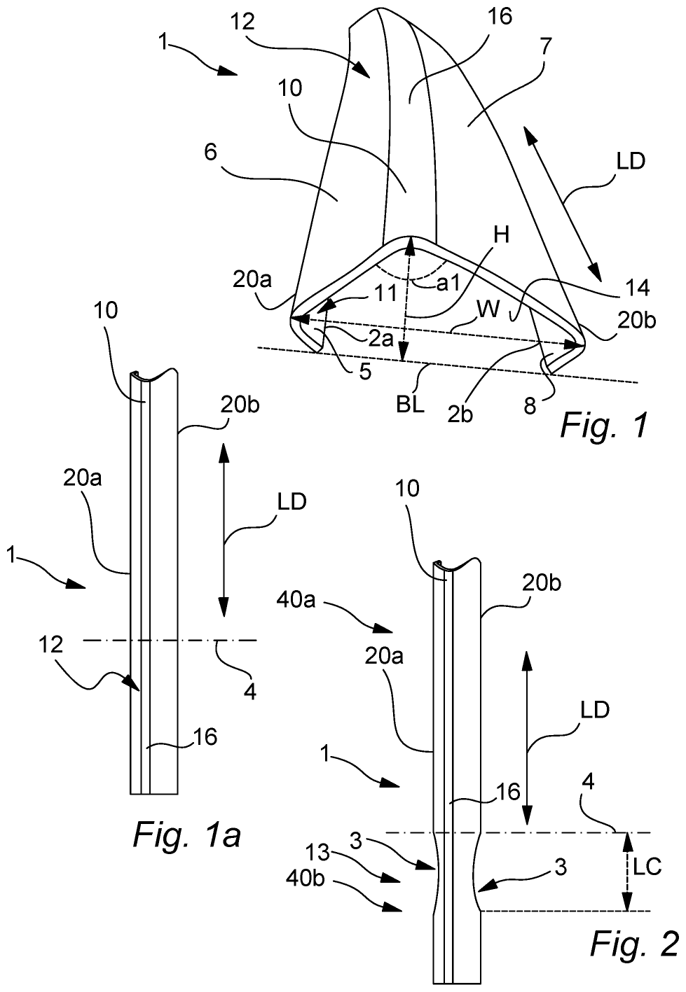

FIG. 1a illustrates schematically a trim profile 1 according to an embodiment of the present disclosure, seen in perspective and towards an end of the profile, and FIG. 1b illustrates the same profile seen from above towards a bend 10. The trim profile 1 comprises a plurality of bends extending in the longitudinal direction LD of the trim profile 1. These bends comprises a first bend 10 providing an elongated crest/ridge 16, and one or more second bends 20 placed between the first bend 10 and one of the side edges 2a, 2b of the trim profile. Hence, the bends 10, 20a, 20b are arranged between side edges 2a, 2b of the profile 1, which extends in the longitudinal direction LD of the trim profile. Thereby, the bends shapes an interior surface 11 and an exterior surface 12 of the trim profile 1. The exterior surface comprises one or more convex surfaces due to the bends 10, 20a, 20b, whereas the interior surface comprises one or more concave surfaces provided by the bends 10, 20a, 20b.

In FIG. 1, the trim profile 1 has a C-shape seen in in cross section (in a plane extending transverse and perpendicular to the longitudinal direction LS), where the C-shape is provided by the first bend and further bends 20a, 20b.

The bends 10, 20a, 20b of the trim profile 1 provides elongated wall parts extending in the longitudinal direction LD of the trim profile. These elongated wall parts comprises a first wall part 6 extending between the first bend 10 and a second bend 20a, and furthermore a second wall part 7 arranged between the first bend 10 and a further second bend of the trim profile. Additionally, the trim profile 1 comprises a third wall 5 part extending between the second bend (20a) and a first side edge (2a), and a fourth wall part 8 extending between the other side edge 2b and the further second bend 20b, The second bends 20a, 20b hence extends between the first bend 10 and the respective side edges 2a, 2b of the trim profile 1.

In FIG. 1, the exterior surface 12 at the “vertex” of the bends 20a, 20b provides the largest width W of the profile, Moreover, in FIG. 1, the maximum height H of the profile is defined between the “vertex” of the first bend 19 at the exterior surface 12, and towards and perpendicular to an envisaged bottom line BL drawn between the edges 2a, 2b of the profile.

At least one of the bends 10, 20a, 20b, such as the first bend 10 as illustrated in FIG. 1 may provide a first wall part 6 and a second wall part 7 with a bend angle there between. The bend angle a1 between the first and second wall parts 6, 7 may in embodiments of the present disclosure be between 45° and 150°, such as between 85° and 130°, for example between 100° and 120°. The same may apply for one or both second bends 20a, 20b in further embodiments of the present disclosure.

In embodiments of the present disclosure, the width W of the trim profile 1 may be between 2 mm and 50 mm, such as between 3 mm and 20 mm, such as between 4 mm and 15 mm.

In embodiments of the present disclosure, the height H of the trim profile 1 may be between 2 mm and 50 mm, such as between 3 mm and 20 mm, such as between 4 mm and 15 mm.

In preferred embodiments of the present disclosure, the trim profile is made from a metal plate material in the form of a steel material such as a stainless steel material, for example a chromium-nickel stainless steel material. In embodiments of the present disclosure, the steel material comprises at least 12% by weight of chrome (Cr).

For example, the steel material of the profile 1 may in embodiments of the present disclosure be a SUS 304 (Japanese Industrial Standards (JIN)) grade steel or a SUS 304L grade steel. In certain embodiments of the present disclosure, the steel may be a 1.4301/AISI 304/X5CrNi18-10 stainless steel. Even though the trim profile may preferably be a steel, such as a stainless steel profile, the metal profile may also be made from a metal of another material than steel, e.g. aluminium, brass or copper or other metals or metal alloys, in other aspects of the present disclosure.

The material of the trim profile 1 has a wall thickness between 0.2 mm and 1.0 mm such as between 0.3 mm and 0.8 mm, preferably between 0.4 mm and 0.6 mm. For example, in some embodiments, the wall thickness of the trim profile material may be about 0.5 mm. This wall thickness is defined between the interior and exterior surfaces 11, 12.

The material of the trim profile 1 may in other embodiments of the present disclosure a wall thickness between 0.2 mm and 3 mm such as between 0.3 mm and 1.5 mm.

This may e.g. be relevant if the trim profile material is aluminium alloy material or another material softer than stainless steel, but it may also apply for stainless steel profiles.

The bends 10, 12a, 12 may preferably have been made by means of roll forming. Alternatively, the trim profile 1 may be a trim profile that has been extruded and/or pultruded in order to provide the shape with the bends 10, 20a, 20b.

In FIG. 1 a, a dash/dotted bending line 4 is illustrated. This line represents a location where an end wall is desired to be provided on the trim profile 1.

It is generally understood that the trim profile after manufacturing according to embodiments of the present disclosure may be used for decorative metal trim profiles for vehicles, such as four wheeled vehicles, e.g. cars, trucks or the like, or vessels such as boats, or in any other suitable usage such as for example as decorative elongated trim profiles for building parts or furniture. The decorative trim profiles may be decorative in the sense that they are visually aesthetically appealing to the eye, that is, they may be substantially evenly smooth and shiny, and even reflective, as is e.g. commonly employed for window trims in the automotive industry, such as for a two- and/or four-wheeled automotive.

FIG. 2 illustrates an embodiment of the present disclosure where a cut-out operation has been provided before shaping an end wall part on the profile 1.

The trim profile 1 comprises a first elongated part 40a that is to be used for the final trim profile, and a second part 40b that used for shaping and providing the end cap/end wall 30 (see figures described below) on the trim profile. The line 4 provides the border between the first and second parts 40a, 40b.

Prior to shaping the end wall, a cut out operation may be provided where a cut out 3 is provided at the second bend(s) 20a, 20b in the end wall area 13 of the second part 40b in order to remove at least a part of the trim profile material at the one or more second bends 20a, 20b.

In embodiments of the present disclosure, cut out 3 may have a length LC that is between 0.2 and 3 times, such as between 0.5 and 1.5 times the height H of the trim profile 1. In embodiments of the present disclosure, cut out 3 may have a length LC which is larger than 0.2 times the height of the trim profile, such as larger than 0.5 and times the height H of the trim profile 1. In other embodiments, the cut out(s) 3 may possibly be omitted.

The cut outs 3 are provided in order to remove the walls 5, 8 in the area, and may also as illustrated extend at least partly into the walls 6, 7. However, in other embodiments, the cut outs 3 may be provided in order to remove the walls 5, 8 and the bends 20a, 20b alone.

As can be seen especially at FIG. 1, the bends 10, 20a, 20b extending in the longitudinal direction LD of the trim profile provides an interior space 14 in the elongated profile 1, where at least two, such as at least three, for example at least four walls 5, 6, 7, 8 of the trim profile extending in the longitudinal direction encloses the interior space 14. In the example of FIG. 1, the four walls 5-8 provides the interior space 14. The cross sectional area of the interior space 14 determined between the walls and enclosed by an envisaged bottom line BL drawn between the side edges 2a, 2b of the profile extending in the longitudinal direction may in embodiments of the present disclosure be between 0.5 cm² and 8 cm², such as between 0.5 cm² and 5 cm², for example between 1 cm² and 4 cm²

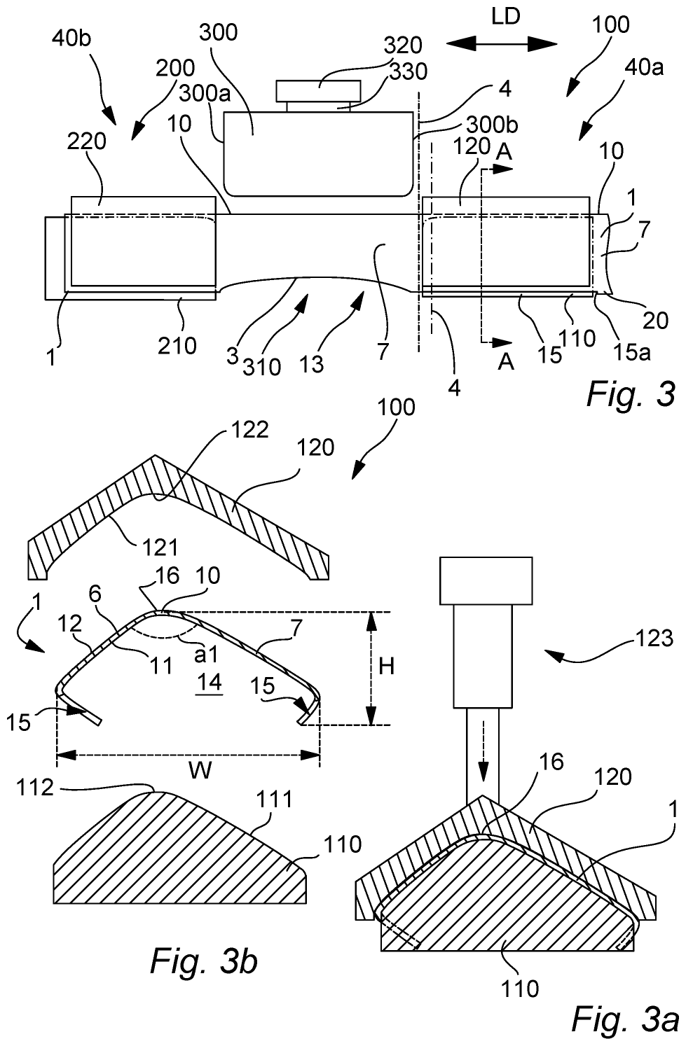

FIG. 3 illustrates schematically an embodiment of the present disclosure wherein the trim profile 1 (seen from the side) is placed in a deep drawing arrangement according to embodiments of the present disclosure.

The deep drawing arrangement comprises a first fixation arrangement 100 and a second fixation arrangement 200. The part 40a of the trim profile is arranged in the first fixation arrangement 100, and the part 40b of the trim profile is arranged in the second fixation arrangement 200.

A working space 310 is provided between the first and second fixation arrangements 100, 200, and a stamp 300 is configured to be displaced into the working space. The working space is arranged opposite to a surface 114 of an interior support part 110 of the first fixation arrangement 100, which will face the end wall part 30a during the deep drawing operation.

FIG. 3a illustrates a cross section of the first fixation arrangement trough the view “A-A” illustrated in FIG. 3, and FIG. 3b illustrates an exploded view of FIG. 3a where fixation arrangement and trim profile 1 are separated.

The fixation arrangement 100 illustrated in FIGS. 3, 3a and 3b comprises an interior support part 110 arranged in the interior space 14 of the trim profile which is enclosed by the interior surface 11. The interior support part 110 comprises a support surface 111 shaped to follow, abut and support the interior surface 11 of the trim profile 1. The fixation arrangement 100 moreover comprises an exterior support part 120 arranged at the exterior surface 12. The exterior support part 120 comprises a support surface 121 shaped to support and abut the exterior surface 12 the elongated metal trim profile during a subsequent deep drawing operation in order to provide an end wall on the profile in the area of the bend line 4.

The first part 40a of the trim profile is arranged and held between the interior support part 110 and the exterior support part 120.

The support surface 111 of the interior support part 110 comprises a ridge 112 configured to extend into the concavely shaped recess/valley of the interior surface 11 of the trim profile which is shaped by the bend 10. This ridge 112 extends in the longitudinal direction LD of the trim profile 1 and comprises a surface curvature that substantially matches the internal surface curvature at the bend 10 at the interior surface 11. Hence, the trim profile material at the bend 10 supports on the ridge 112 of the interior support part. The remaining part of the interior support part 110 supports the walls 6, 7 of the trim profile.

The exterior support part 120 comprises a support/counter hold surface 121. This surface comprises a recessed portion 122 in the support surface 121 into which the bend 10 of the trim profile extends. Hence, the exterior surface 12 of the trim at the location of the ridge extends into the recessed portion 122, and the remaining part of the exterior support part 120 supports on the walls 6, 7 of the trim profile. Hence the trim profile remain the desired shape provided by the bends in the longitudinal direction of the trim profile, which substantially is the final shape of the trim profile, while it is supported between the support parts 120, 110.

A fixation arrangement control device 123 illustrated in FIG. 3a may be configured to control the distance between the support surfaces 111, 121 of the support parts 110, 120 and e.g. also control the force with which the support surfaces 111, 121 presses towards the profile 1 in order to fixate and possibly clamp the fixation profile 1 between the support parts during a subsequent deep drawing operation as described further below. The fixation arrangement control device 123 may e.g. be an adjustable spring arrangement or an active control device such as a controllable linear actuator such as an electric actuator or the like, or a combination thereof.

The second fixation arrangement 200 may be substantially similar in design to the first fixation arrangement 100 and may accordingly comprises support parts 220, 210 which are shaped and arranged in a similar way as the parts 110, 120 of the fixation arrangement. A further fixation arrangement control device (not illustrated) may be configured to control the second fixation arrangement.

As can be seen, the cut out 3 (if present) may be placed opposite to the working

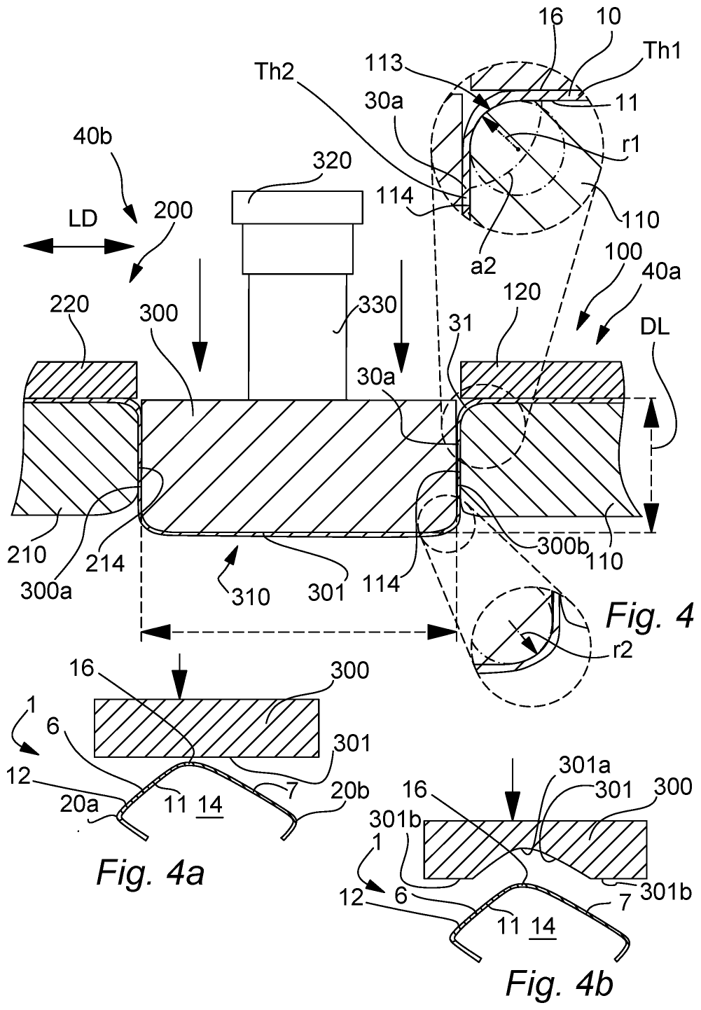

FIG. 4 also illustrates an embodiment of the present disclosure, where a further cut out 15 (also referred to as a further cut out in the present document) is provided in the part 40a, see also FIG. 3b and FIG. 8. This further cut out 15 is provided in the lower part of the profile 1 and removes at least a part, if not all of the wall material of the walls 5, 8. This provides that the interior support part can be removed after the deep drawing process. The further cut out 15 starts at a position 15a at the part 40a and extends here from the end wall parts 5, 8 that are not removed at the part 40a, and to the cut out 3, which in embodiments of the present disclosure may have removed more material and hence extend into the wall parts 6, 7.

FIG. 4. Illustrates schematically a deep drawing operation seen in a cross sectional view in the longitudinal direction of the trim profile 1 according to embodiments of the present disclosure. When the trim profile 1 has been arranged properly in the fixation arrangements 100, 200, a deep drawing operation is provided by providing a relative displacement between a stamping tool 300 and the first and second fixation arrangements 100, 200 in a direction transverse to the longitudinal direction LD of the trim profile 1. Hereby the stamping tool 300 moves into the working space 310, and deforms the trim profile material in the end wall area 13 into the working space. The deep drawing operation thereby provides an end wall part 30a on the trim profile.

The relative displacement during the deep drawing operation in order to bring the stamping tool into the working space 310 and deform the trim profile to provide the end wall part 30a is preferably provided by keeping the first and second fixation arrangements 100, 200 in a fixed position and moving the stamping tool 300 into the working space. However, in other embodiments, the first and second fixation arrangements 100, 200 may be moved while keeping the stamping tool fixed. In still further embodiments, the first and second fixation arrangements 100, 200 may be moved in a first direction transverse to the longitudinal direction LD while the stamping tool is also moved in the opposite direction opposite to the longitudinal direction.

In FIG. 4, a driver device 320, such as a motor, e.g. an electric motor such as a servo motor (which may be preferred) or a stepper motor, provides the displacement of the stamping tool 300 into the working space 310 by operating an actuator 330, such as a linear actuator, for example a spindle drive connecting the driver device 320 and the stamping tool 300.

The stamping tool 300 may, dependent on the shape of the contact surface of the stamping tool which is pressed towards the trim profile material to provide the deep drawing, start the deep drawing operation by abutting and deforming the upper ridge of the trim profile which is provided by the bend 10 extending in the longitudinal direction (LD) of the trim profile as e.g. described previously.

The deep drawing hence provide a drawing of the trim profile 1 metal sheet material and may hence make the end wall 30a part material thinner Th2 than the general/initial material thickness Th1 of the trim profile, while the remaining part of the trim profile such as the elongated walls 5-8 that are present on the trim profile at the part 40a remains the initial sheet thickness Th1. In return, the end wall part 30a is formed which extends in a direction different from the longitudinal direction LD of the trim profile, and which so to say closes off the end of the trim profile part 40a and covers the interior space 14 of the trim profile.

As can be seen in FIG. 4, the interior support part 110 comprises a corner part/corner support portion 113 that defines the internal bending radius r1 of the corner bend provided between the part 40a and the end wall part 30a when the deep drawing operation is provided. The inner bending radius r1 at the end wall 30, which is provided due to the deep drawing operation may in embodiments of the present disclosure be below 3 mm, such as below 2 mm, for example below 1.5 mm. The bending radius r1 provided by the deep drawing operation may substantially be the desired bending radius at the final trim, or may be adapted a little after the deep drawing operation in a further processing step.

In embodiments of the present disclosure, the inner radius r1 may, after the deep drawing operation and provided by the deep drawing operation may be below 1 mm, such as below 0.8 mm or below 0.6 mm.

Generally in embodiments of the present disclosure, the inner radius after the deep drawing operation and provided by the deep drawing operation may be between 0.2 mm and 5 mm, such as between 0.2 mm and 3 mm, for example between 0.3 mm and 2 mm.

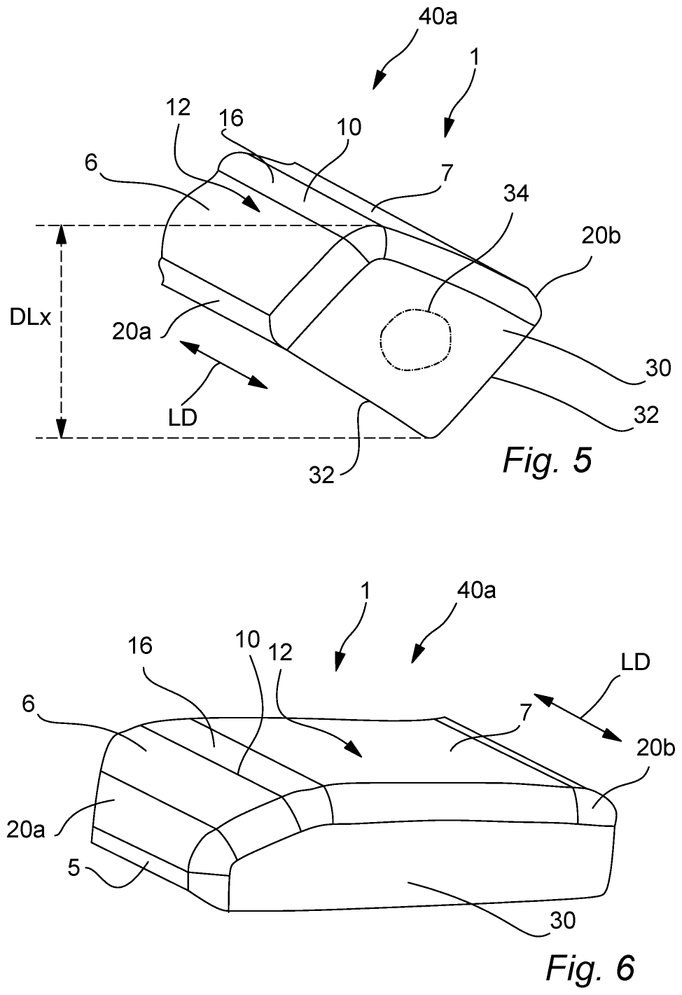

The deep drawing operation stretches the metal wall of the trim profile at and/or near the end wall. This may as illustrated provide that the wall thickness of an area (34—see FIG. 5) of the end wall part 30a (and at the final end wall) may be at least 10%, such as at least 20%, for example at least 30% lower than the general material thickness (th2) of the trim profile. This area with the thinner sheet material thickness is located at the plane wall part of the end wall part 30a such as at a centre part of the end wall as illustrated in FIG. 5. For example, at least 20% such as at least 30% e.g. at least 40% of the end wall part may have a wall thickness Th2 that is lower than the initial wall thickness th1 of the trim profile before the deep drawing operation.

The deep drawing operation provides a draw length DL by means of the stamping tool 300. This draw length DL is determined by the largest draw length provided at the trim profile 1 in order to deform the trim profile at the part 40b and thereby obtain the end cap part 30a. This draw length may be at least 5 mm, such as at least 9 mm, for example at least 13 mm. The draw length DL may in embodiments of the present disclosure be between 5 mm and 30 mm, such as between 9 mm and 20 mm, for example between 13 mm and 18 mm.

The bend angle a2 (referred to as “bend angle” even though it is obtained by the deep drawing) between the end wall part 30a and the walls 6, 7 and the recess in the interior surface 11 provided by the bend 10, which is provided by the deep drawing operation, may in embodiments of the present disclosure be between 60° and 120°, such as between 70° and 105°, for example between 85° and 95°, e.g. such as 90°±2°. This angle a2 may be defined by the movement direction and/or shape of the stamping tool 300.

In embodiments of the present disclosure, the first fixation arrangement 100 provides a tighter grip and hold on the first part 40a that is to be used for the final trim, than the second fixation arrangement 200 holds/fixates the second part 40b.

Hence, during the deep drawing process, the second fixation arrangement may allow a part of the trim profile material between the parts 220, 210 to slide/move into the working space due to the forced provided by the tool 300 on the trim profile material. However, less material may be allowed to slide between the parts 110, 120 of the first fixation arrangement during the deep drawing operation.

In certain embodiments of the present disclosure, the first fixation arrangement may provide a firm grip on the trim profile part 40a so that substantially no sliding of the trim profile part 40a material between the holding parts 110, 120 in the longitudinal direction LD of the trim profile is provided during the deep drawing operation.

The stamping tool 300 has a length TL extending in the longitudinal direction LD of the trim profile 1 between the tool ends 300a, 300b. The length TL may in embodiments of the present disclosure be between 5 mm and 40 mm, such as between 10 mm and 30 mm, for example between 20 mm and 30 mm. The lower the length TL, the less of the material 40b may become excess material and thus subsequently scrapped after the deep drawing operation, and hence utilization of the trim profile 1 may be increased.

FIGS. 4a-4b illustrates, seen through a cross sectional plane that extends perpendicular to the longitudinal direction of the trim profile, various embodiments of the stamping tool surface 301 of the stamping tool 300 which may be used for deforming the trim profile during the deep draw operation according to embodiments of the present disclosure. In FIG. 4a, the stamping surface 301 of the tool 300 is substantially straight and will initiate the pressing on the crest 16 during the deep drawing operation. In FIG. 4b the surface 301 comprises a recess 301 shaped to receive the crest 16 and is divided into two parts, the first part comprising the recessed portion 301 and a second part 301b which is not shaped to accommodate the curvature of the surface 12. In further embodiments of the present disclosure (not illustrated but envisaged as seeing through a plane as in FIGS. 4a and 4b), the surface 301 may be convexly shaped and may have a top point that may initially start to provide a deformation of the crest 10 at initiation of the deep drawing operation.

FIG. 4 moreover illustrates a further curvature radius of the corner radius r2 of the stamping tool 300 according to further embodiments of the present disclosure. The corner radius is the radius at the corner of the tool 300 in the transition between the stamping surface 301 and the end surface 300b. The radius r2 may preferably be larger than 5 mm such s larger than 10 mm, or even larger such as larger than 15 or larger than 20 mm. In embodiments of the present disclosure, the radius r2 may be so large that substantially the entire stamping surface 310 is curved between the ends 300a, 300b and thus provides a convex surface.

FIG. 5 illustrates in perspective a view towards an end wall/end cap 30 provided at the final trim profile of the trim profile part 40a. Here, the end wall 30 has a height DLx that has been provided by the deep drawing operation. The height DLx has a lenth that is equal to or less than the draw length DL provided by the deep drawing operation.

The height DLx may be larger than (e.g. at least 3% such as at least 5% larger) than the height H (see FIG. 1) of the trim profile, and hence the draw length DL (see FIG. 4) may be larger than the height H of the trim profile.

As can be seen from FIG. 5, the end wall 30 of the final profile has been separated from the excess material provided during the deep drawing operation and has been cut into a desired shape, in the present example a rhombus shape, but it may also be cut into e.g. a rectangular or triangular shape dependent on which shape is desired.

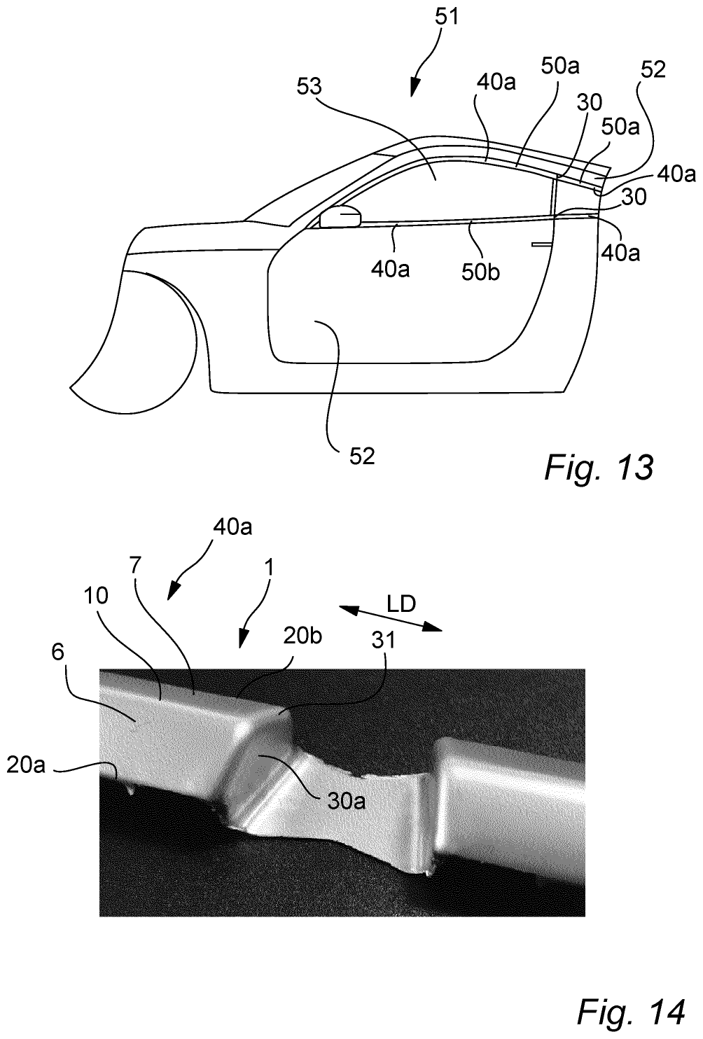

FIG. 6 illustrates another embodiment of a trim profile according to embodiments of the present disclosure where the trim profile has another shape, and where the end wall has been provided by a deep drawing operation as previously disclosed. This shape may be suitable for e.g. upper 50a window trims on e.g. doors of a vehicle (see FIG. 13).

The trim profile illustrated in FIG. 5 (see also FIGS. 1 and la) may be suitable for lower window trims—see FIGS. 13-50b. The lower trim profile 50b may in some situations be more complex to provide a suitable end wall solution on as the shape of the profile must be visually pleasing and at the same time the trim 50b design may need to comprise and/or support one or more sealing solutions in order to obtain a suitable sealing, and possibly also dew removal, between a vehicle window that can be displaced to an open and closed position in a vehicle door relative to the trim profile 50b.

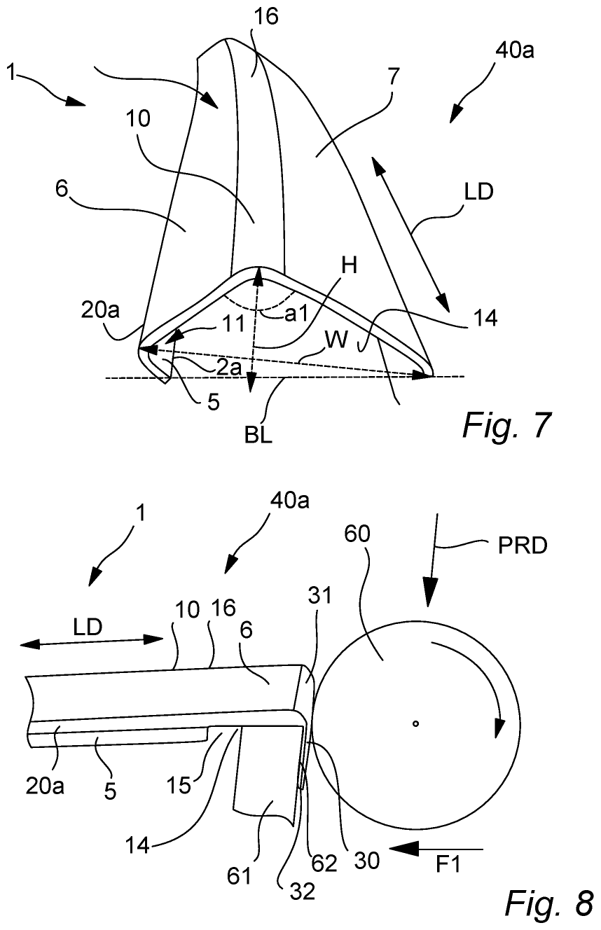

FIG. 7 illustrates schematically and in perspective a further embodiment of a trim profile 1 on which an end wall/end cap may be provided by means of a manufacturing process including the deep drawing operation as described above according to embodiments of the present disclosure. This profile is substantially similar to the profile illustrated in FIG. 1, though where the wall 5 has been omitted.

FIG. 8 illustrates an embodiment of the present disclosure where the end wall 30 part is further processed in order to obtain a desired surface and/or shape. Here, an end wall processing device 60 such as a rotating wheel as illustrated is used for processing such as roller shaping, grinding and/or polishing on the exterior surface of the end wall 30. The processing device 60 is pressed against the exterior surface of the end wall 30 with a force F1, and an interior end wall support 61 is arranged in the interior of the profile in order to support the end wall and provide a counter force to the force F1 from the device 60. The interior end wall support 61 comprises hence an end wall support surface 62 arranged with an angle relative to the longitudinal direction LD of the trim profile 1, and thereby to ensure that the end wall 30 is either supported at the initial desired angle, or maintained at the desired angle after the force F1 has been provided.

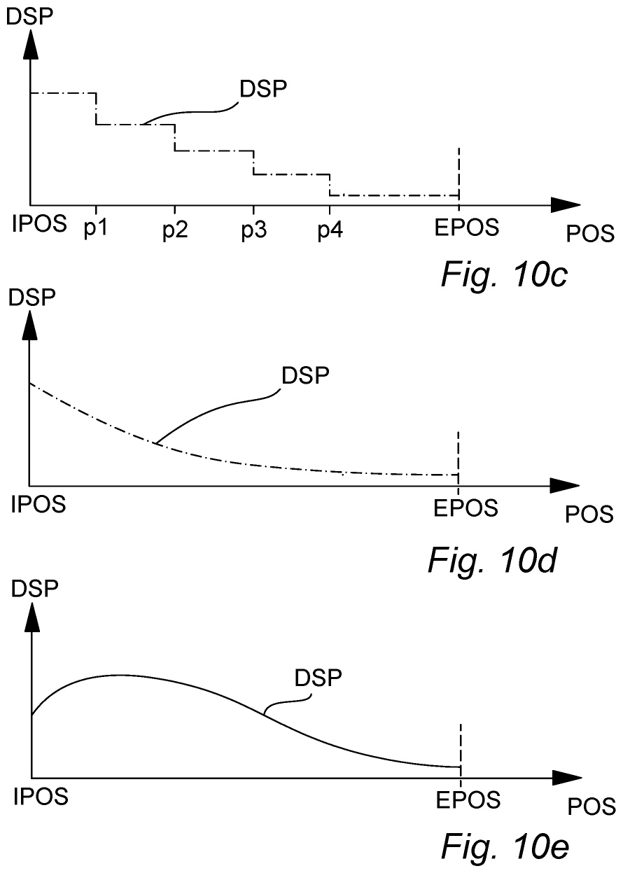

The end wall processing device 60 may in preferred embodiments be moved relative to the trim profile 1 from the bended corner 31 of the end wall 30 and towards the edge of the end wall opposite the corner 31. Preferably, the device 60 may be moved from the ridge provided by the bend 10 and toward the lower edge 32 of the end wall 30 in the processing direction PRD where the surface of the end wall is processed by the end wall processing device 60. Even though the end wall processing device is illustrated as being a rotating wheel in FIG. 10, it is understood that the processing device may also e.g. be a plate another type of processing device arranged to be slided/displaced over the surface of the end wall to provide a treatment of the end wall part surface.

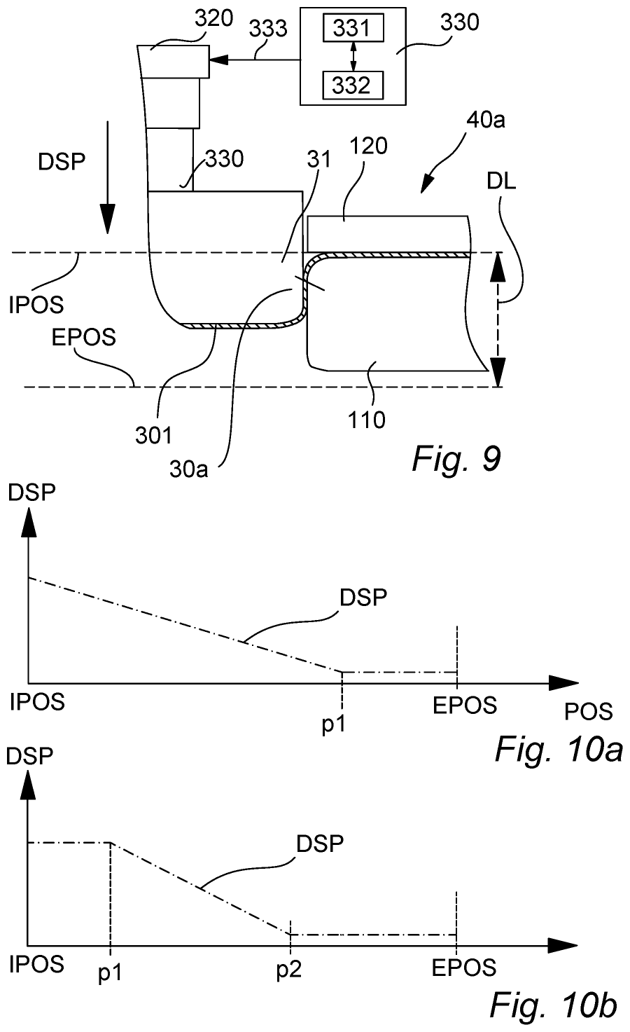

FIG. 9 illustrates schematically an embodiment of the present disclosure relating to the deep drawing operation wherein the speed DSP with which the stamping tool 300 is displaced is regulated during the deep drawing operation.

The displacement speed DSP of the tool 300 is in FIG. 9 changed during the deep drawing operation between the initial position IPOS where the deep drawing is initiated and starts to deform the trim profile 1, and the end position EPOS position where the deep drawing operation is ended. These two positions IPOS, EPOS defines the draw length DL extending there between as previously described.

Varying the displacement speed DSP of the tool 300 may help to ensure a successful deep drawing operation in order to obtain an end wall part of sufficient quality, also in thinner material such as steel material, e.g. stainless steel material, having a wall thickness between 0.2 mm and 1.0 mm such as between 0.3 mm and 0.8 mm, preferably between 0.4 mm and 0.6 mm.

The displacement speed DSP speed may in embodiments of the present disclosure be changed by e.g. reducing the speed of the tool 300 during the deep drawing process by e.g. providing a gradual reduction of the draw speed DSP1 from the initial position IPOS to the end position EPOS.

A control system 300 comprising control circuitry including a computer processor 331 and a data storage 332 provides the control by control signals 333 of the driver device 320 such as a servo motor, e.g. an electrical servo motor, for example a stepper motor or any other type of motor. The control system 330 operates according to a program code stored in the data storage 332 in order to provide a desired displacement speed profile of the tool 300 during the deep drawing operation. The driver device 320 or another sensor device may in embodiments of the present disclosure provide position feedback (not illustrated) to the control system, e.g. from one or more position sensors (not illustrated), in order for the control system to control the displacement of the tool 300. Though, such position feedback may also be omitted in other embodiments of the present disclosure, and the displacement speed may alone be controlled by a predetermined displacement profile program code stored in the data storage 332.

The acceleration of the displacement device from the initial position IPOS to the end position EPOS may in further embodiments of the present disclosure also be a control parameter that is regulated and changed by the control system 330 from the initial position IPOS to the end position EPOS based on a software program in the data storage.

FIGS. 10a-10e illustrates different embodiments of displacement speed profiles for the tool 300 according to embodiments of the present disclosure. Here, the displacement speed of the tool 300 is controlled by a controller 330 to be changed from the initial position IPOS to the end position EPOS according to the displacement speed profile.

This speed change may in embodiments of the present disclosure be provided based a predetermined speed profile that is dependent on the (present or predicted) position of the tool 300 during the deep drawing operation. This may be determined based on position information/data from an encoder of the like on the driver 320, or by counting steps if the driver 320 is a stepper motor. Additionally or alternatively, the displacement speed of the tool 300 may be controlled and varied based on input from one or more sensors (not illustrated) such as one or more force sensors arranged to determine directly or indirectly a force applied to the trim profile during the deep drawing operation to provide the end wall part 30a. The force sensor(s) may be a strain gauge sensor, or it may be a current monitor/sensor configured to detect/monitor the electrical current provided to the driver device 320, and the controller 330 may control the speed of the displacement of the tool 300 accordingly during the deep drawing process based on the input from the force sensor(s). As the electrical current consumed by the driver 320 will increase when increased force is applied, this current may indirectly be representative of the force applied. It is understood that any other suitable means for determining tool 300 position and/or force applied may be provided in further embodiments of the present disclosure.

In FIG. 10a, the displacement speed DSP of the tool 300 is reduced gradually from the initial position IPOS to the end position EPOS. In FIG. 10a, the tool reaches a point p1 where the speed DSP is kept substantially constant from that point and to the end position EPOS. Though, it is understood that the displacement speed DSP may also be reduced gradually all the way from the initial position IPOS to the end position EPOS.

In FIG. 10b, the displacement speed DSP of the drawing tool is also reduced gradually from the initial position IPOS to the end position EPOS. However in this embodiment, between the initial position IPOS and a first point p1, the displacement speed DSP is kept constant, between the first point p1 and the second point P2, the speed is gradually decreased, and from the second point p2 to the end position, the speed DSP is kept substantially constant from that point p2 and to the end position EPOS. Though the speed between p2 and the end position EPOS is substantially lower than the speed between the initial position IPOS and the first point p1 due to the speed reduction provided between the first point p1 and the second point p2.

FIG. 10c illustrates an embodiment of the present disclosure where a stepwise speed change is provided at certain points p1-p4 between the initial position IPOS and the end position EPOS. In FIG. 10c, the stepwise speed changes comprises a speed reduction at each point p1-p4. However, it may also in further embodiments of the present disclosure comprise a speed increase (not illustrated in FIG. 10c) between two consecutive points IPOS, p1 -p4, EPOS between the initial position IPOS and end position EPOS.

FIG. 10d illustrates an embodiment of the present disclosure where the speed change between the initial position IPOS and the end position EPOS is un-linear, and the gradient

$$( \frac{d POS ( t )}{dt} )$$

of the displacement hence changes from the initial position IPOS to the end position EPOS. This may be controlled to be provided gradually or stepwise from the initial position IPOS to the end position EPOS.

FIG. 10e illustrates an embodiment of the present disclosure where the speed of the tool between the initial position IPOS and the end position EPOS both increases and decreases. This may e.g. help to provide certain desired characteristics of the trim profile material during the deep drawing operation from the initial position to the end position.

For several of the embodiments disclosed in FIGS. 10a-10e, the displacement speed DSP is reduced over time from the initial position IPOS to the end position EPOS.

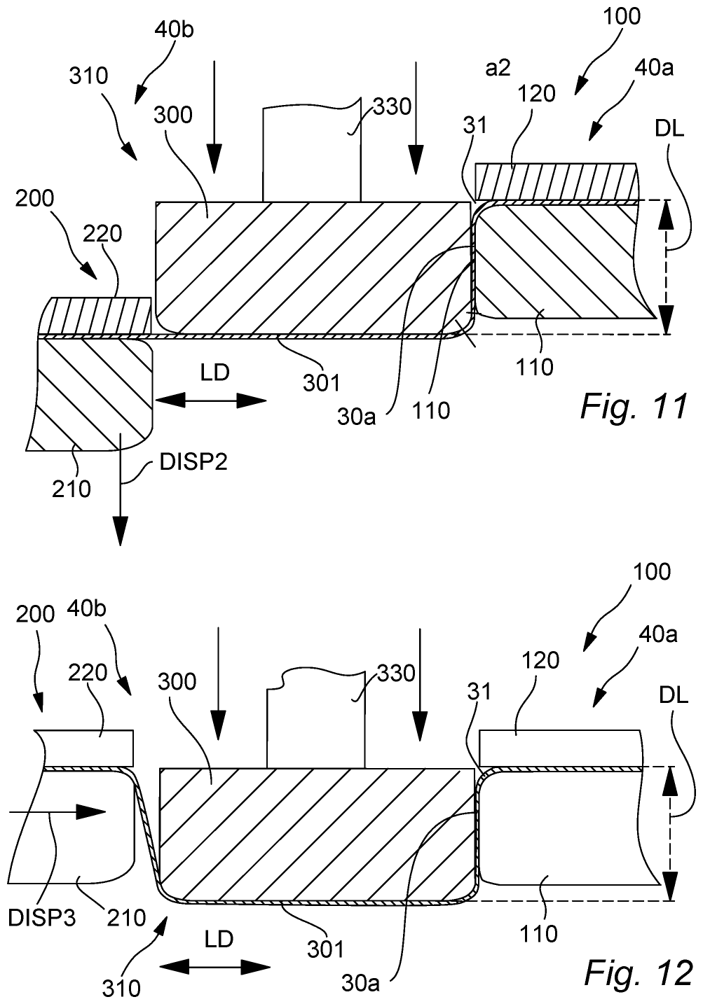

FIG. 11 illustrates schematically an embodiment of the present disclosure wherein the second fixation arrangement 200 provides a displacement DIS2 transverse to the longitudinal direction of the trim profile 1 during the deep drawing operation. This may help to enable that more trim profile material may be available for the deep drawing operation in order to provide the end wall part 30a, as less stretching of the wall material may be needed near the second fixation arrangement as compared to the illustrated embodiment of FIG. 4. This may allow for a more firm and/or controlled grip on the trim profile by the second fixation arrangement 200. The second fixation arrangement 200 may here e.g. follow DISP2 the movement of the stamping tool and be displaced with a speed that is the lower or equal to the speed of the stamping tool. Also in FIG. 11, the working space 310 is arranged opposite to a surface 114 of an interior support part 110 of the first fixation arrangement 100, which will face the end wall part 30a during the deep drawing operation. The end 300b of the tool 300 faces the surface 114 during the deep drawing operation when the tool is in the working space.

FIG. 12 illustrates schematically an embodiment of the present disclosure wherein the second displacement arrangement 200 is moved DISP3 towards the working space 310 in order to reduce the stretching at a part of the trim profile material near the fixation arrangement. This movement DISP3 may be a movement controlled by a displacement arrangement (not illustrated) actively controlled by the control system 330 as previously explained, the fixation arrangement 200 may be connected to a passive spring or damper arrangement that provides a counterforce against the movement DISP3 and/or the like. Also in FIG. 12, the working space 310 is arranged opposite to a surface 114 of an interior support part 110 of the first fixation arrangement 100, which will face the end wall part 30a during the deep drawing operation.

In FIG. 4, the working space 310 is provided between the first and second fixation arrangements 100, 200, and between opposing walls 114, 214 of the interior support parts 210, 110 during substantially the entire deep drawing operation, and the same applies for the solution illustrated in FIG. 12. In FIG. 11, the working space 310 is defined between the walls 114, 214 of the first and second fixation arrangements 100, 200 before the deep drawing operation is initiated. For all three situations, the working space 310 is arranged opposite to a surface 114 of an interior support part 110 of the first fixation arrangement 100, which will face the end wall part 30a during the deep drawing operation.

FIG. 13 illustrates schematically a vehicle 51 seen from the side comprising trim profiles 50a, 50b provided according to embodiments the present disclosure. The deep drawing solution as disclosed according to the present disclosure may be suitable for providing end walls 30 on various designs of trim profiles, including upper and lower trim profiles 50a, 50b in window openings 54, and also on trim profiles having more complex cross sectional shapes and bend angles, such as bend angles a1 (see e.g. FIG. 1) between trim profile walls that is/are between 45° and 150°, such as between 85° and 130°, for example between 100° and 120°. Only a front door 52 at the vehicle in FIG. 13 is illustrated, but it is naturally understood that trim profiles 50a, 50b may also be provided at rear doors of the vehicle. Upper trim profiles 50a may here be arranged in continuation of each other (as illustrated), and the same may lower trim profiles 50b when the doors are closed. End walls of the trim profiles on the front door may thus be arranged to face end walls on trims on the rear door. If a rear door is absent, a trim profile with an end wall 30 may still be placed on the vehicle body.

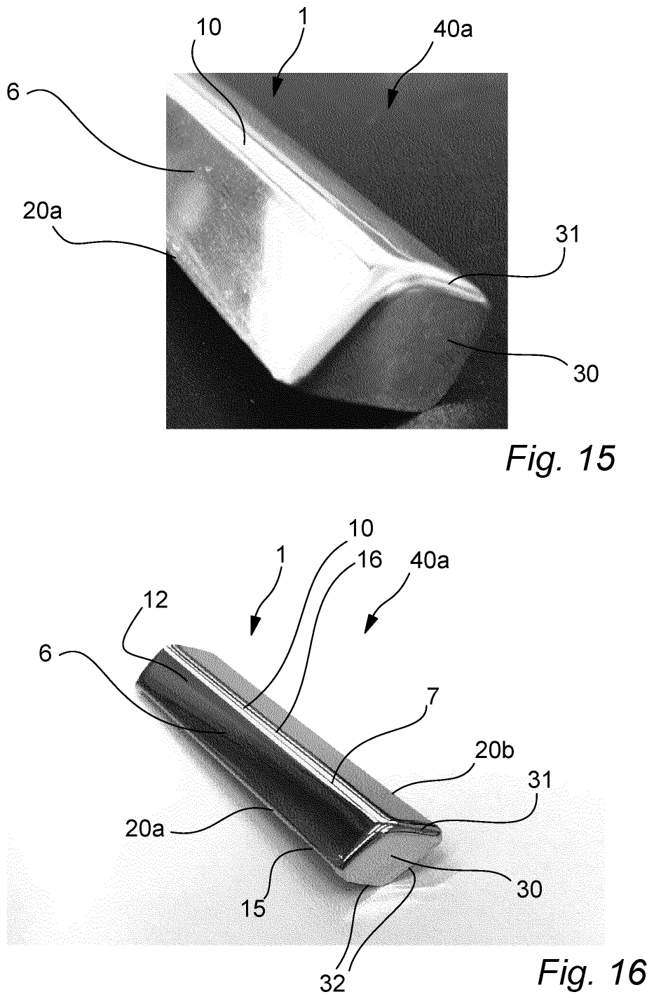

FIG. 14 illustrates a photo of a stainless steel trim profile (as an intermediate product) that have been exposed to a deep drawing operation according to the present disclosure. The metal sheet material of the trim profile 1 is a stainless steel material having a thickness of about 0.5 mm. Here, it can be seen that an end wall part 30a has been formed and encloses the interior space of the trim profile. The profile used in FIG. 14 is substantially similar to the profile describe in relation to FIGS. 1 and 1 a. Excess material form the deep drawing process is still present in FIG. 15.

FIG. 15 illustrates a photo of the steel trim profile of FIG. 14 after a further processing of the end wall part and removal of excess material at the end wall in order to provide the final end wall 30. The trim profile 1 is here not further processed in order to obtain a desired surface coating at the exterior surface 12.

FIG. 16 illustrates a photo of a final finished trim profile provided by means of a manufacturing process including the deep drawing operation as described above. The trim profile 1 exterior surface 12 has been polished after the deep drawing process to provide the end wall part, and after the excess material has been separated from the end wall 30 and the lower end wall edges 32 have been shaped as desired and shown.

The end wall 30 here comprises lower edges 32 which was previously connected to the excess material. The trim profile depicted at FIG. 8 substantially corresponds to a trim profile made from a trim profile as illustrated in FIGS. 1 and 1 a, and processed into a trim profile as schematically illustrated in FIG. 5.

Instead of a chrome plated surface, the surface 12 may be painted with a paint or in other ways coated with a thin layer of material for decorative and/or protective purpose. The surface may naturally also be kept substantially uncoated, though this may increase the risk of the surface obtaining undesired scratches visible to the human eye.

In one or more examples of the present disclosure, the cut out 3 and/or the further cut out 15 may be provided in order to modify the material behaviour of the trim profile 1 during the deep drawing process and thus the quality of the final product. The material of the trim profile may undergo a more desirable structural and/or visual change by the present method, if the cut out(s) are provided proximate to the desired location of the corner 31 of the end wall 30.

Removing parts of one or more walls 5, 6, 7, 8 near the second bend(s) 20a, 20b, can allow for larger control of the behaviour of the material of the trim profile 1 during the deep drawing operation as less material will be present beneath and/or adjacent the desired location of corner 31 of the bend, thereby reducing the risk of material bulging, ridges and other disadvantageous effects in the final appearance of end wall 30 and the trim profile 1. Removing parts of one or more walls 5, 6, 7, 9 have shown to provide the effect of increased flow of material during the deep drawing process. Thus by careful selection of the shape, size and/or position of the cut-out(s) 3, 15 the direction and/or amount material flow can be controlled to provide the desired appearance of the final product. E.g. by having less material in the walls 5, 8 of the trim profile a larger flow of material along the longitudinal extent of the trim profile can be obtained. As a further example, the location of the cut out(s) 3, 15 can aid in determining from which side of the end wall area 13, and to what extent, material may flow into the working space 310 during the deep drawing process, which in turn provides an easy way of controlling the behaviour of the material and in turn the final product, such as the final material thickness of the end wall (30).

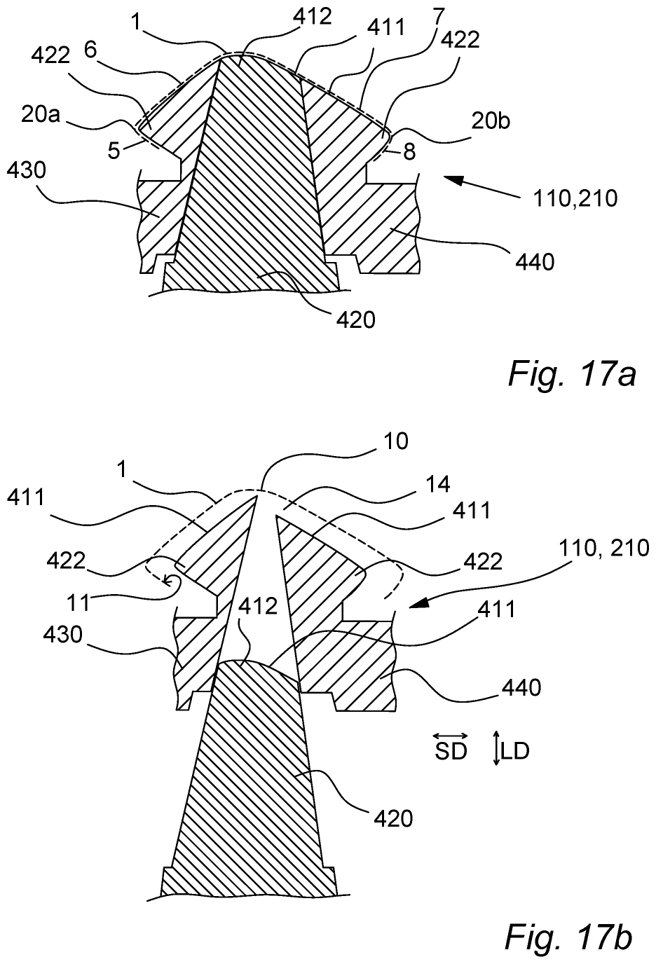

FIG. 17a and FIG. 17b relate to an embodiment of an interior support part 110, 210 of a fixation arrangement 100, 200, wherein the interior support part 110, 210 may be arranged in the interior space 14 of the trim profile, which is enclosed by the interior surface 11. The interior support part 110, 210 comprises a collective support surface 411 shaped to follow, abut and support the interior surface 11 of the trim profile 1 during a subsequent deep drawing operation in order to provide an end wall on the profile in the area of the bend line.

The collective support surface 411 of the interior support part 110, 210 comprises three discrete support elements 420, 430, 440 arranged to be movable relative to each other. A first discrete support element 420 comprises a ridge 412, which is arranged to be moved in and out of abutment with the trim profile 1 at the concavely shaped recess/valley of the interior surface 11 of the trim profile, which is shaped by the bend 10. This ridge 412 extends in the longitudinal direction LD of the trim profile 1 and comprises a surface curvature that substantially matches the internal surface curvature at the bend 10 at the interior surface 11. Hence, the trim profile material at the bend 10 supports on the ridge 412 of the interior support part.

A second support element 430 and third support element 440 are arranged on opposite sides of the first support element 420 and each comprises a protrusion 422, which is arranged to be movable in and out of abutment with the trim profile at the concavely shaped recess/valley of the interior surface 11 of the trim profile provided by a second bend 20a, 20b. The walls 6, 7 may be supported by the first, second and/or third discrete support element 420, 430, 440 preferably such that substantially entire interior surface 11 extending between the second bends 20a, 20b are supported by the interior support part 110, 210. Also the walls 5, 8 may be supported by the interior support part 110, 210 e.g. by the second and third support element 430, 440.

The first support element 420 may be arranged to be movable towards and away from the first bend 10, preferably along a first direction LD, and the first support element 420 is preferably of a wedge shape, having a tip end directed towards the bend, such that when moving the wedge shaped support element away from the bend 10, a space is provided between the second and third support elements 430, 440.

The second and third support elements 430, 440 may thereby be moved away from the walls 6, 7 and the second bend by displacing the elements 430, 440 into the acquired space provided by the movement of the first element 420, such as a long a second direction SD. Thus transferring the interior support part 410 to an unlocked state of decreased collective width of the interior support part 410 compared to the locked state. In the unlocked state, the walls 5, 8 may no longer be prevented from passing the protrusions 422 of the second and third support elements 430, 440 and may thereby lifted/slided from the interior support part 110, 210. A locked state is shown in FIG. 17a and an unlocked state is shown in FIG. 17b, the trim profile 1 is shown by dashed line.

The release of the engagement with the trim profile by transferring the interior support part 110, 210 to an unlocked state makes it easier to displace the trim profile 1 relative to the interior support part 110, 210.

In one or more examples, the first part 40a of the trim profile is arranged and held between an interior support part 110 according to FIGS. 3, 3a, 3b or FIGS. 17a-b and an exterior support part 120 according to the present disclosure. Additionally, also the second part 40b of the trim profile may be arranged and held between an interior part 210 of the same or different construction than the interior part 110 i.e. the one shown and described in relation to FIGS. 3, 3a, 3b or FIGS. 17a, 17b and an exterior support part 220 according to the present disclosure.

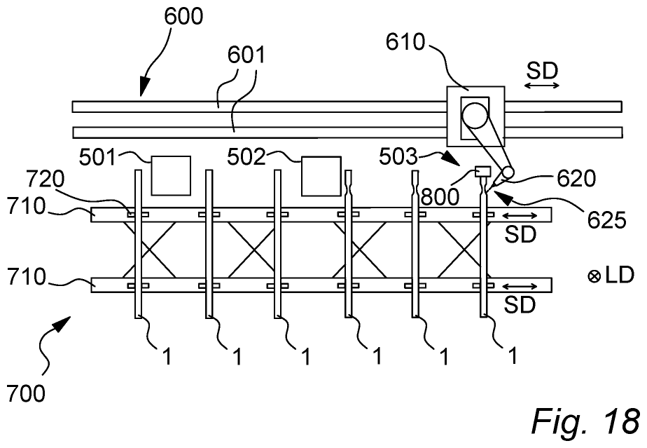

FIG. 18 shows an exemplary execution of the method according to one or more aspects of the disclosure and to manufacturing system for executing the method according to the present disclosure. The trim profile 1 illustrated in FIG. 18, may be a trim profile according to any of the previous embodiments and as illustrated in any of the previous figures.

The manufacturing system comprises a conveyor system 700 having two or more conveyor belts 710 for transferring the trim profiles 1 horizontally along a second direction SD as indicated in the figure. The conveyor system 700 is provided with holding means 720 for holding a trim profile 1 in place, such that the trim profile 1 is not displaced during transfer along the second direction SD. In one or more embodiments, the holding means may comprise an interior support part 110, 210 according to the present disclosure, for holding the trim profile 1. Optionally further fixing means, such as clamps, may be provided at an exterior surface of the trim profile, e.g. such as near wall parts 5, 8, the second bends 20a, 20b and/or the wall parts 6,7 to further fixate the trim profile 1. The trim profile 1 may be transferred in a stepwise manner, such that the trim profile 1 is stationary at each work station 501, 502, 503, while a method step is executed on the trim profile 1.

The manufacturing system is seen comprising at least three work stations 501, 502, 503, a first work station 501 for providing a pre-cutting operation, wherein a cut-out 3 and/or a further cut-out 15 is provided. A second work station 502 where the trim profile 1 is arranged in the first and second fixation arrangements 100, 200 and where the deep drawing operation is undertaken by the stomping tool 300 and a third work station 503 where a post-cutting operation is taking place and where a third fixation arrangement 800 is located for holding excess material to be separated from the trim profile end wall part 30a.

The conveyor system 700 may comprise longitudinal displacement means for displacing the trim profile 1 along a longitudinal extent thereof in and out of the work stations 510, 520, 530, e.g. an end of the trim profile 1 may be displaced in and out of the fixing arrangements 100, 200 and the work space 310 provided in the second work station 520 along a third direction, e.g. being perpendicular to the first direction LD and second direction SD. In one or more embodiments, the conveyor system may comprise vertical displacement means for lifting and lowering the trim profile 1 along the first direction LD, preferably such that the trim profile may be lowering into an interior support part 110, 120.

The pre-cutting operation and the post-cutting operation in FIG. 18 is provided by a laser system 620 mounted on an industrial robot 610 which in turn is mounted on a rail system 600, such that the industrial robot 610 with the laser system 620 can be displaced along the second direction SD between the first and third work station 501, 502 as indicated in the figure.

The method may be executed as follows; a trim profile 1 to be provided with an end wall part 30a is placed in the holding means of the conveyor system 720 and at a first work station 501, either transferred there by the conveyor system 700 or as a part of step of placing the trim profile on the conveyor belts 710. The industrial robot 610 and the laser system 620 is provided at the first work station 501 and the pre-cutting operation, providing a cut-out 3 and/or a further cut out 15 in the trim profile, is provided by means of the laser system 620. The trim profile 1 is thereafter transferred by the conveyor belts 710 to the second work station 502, where a first end 40a is fixed by a first fixation arrangement 100 and the second end 40b is fixed by the second fixation arrangement 200. Preferably, the second end 40b is fixed more loosely than the first end 40b, such that trim profile material may be displaced relative to the second fixation arrangement 200 during the deep drawing operation. The deep drawing operation is then executed and the bend trim profile 1 is transferred by the conveyor system 700 to the third work station 503, where the second end 40b of the trim profile 1 is fixed by a third fixation arrangement 800 and the industrial robot 610 with the laser system 620 is provided at the third work station 503 by means of the rail system 600. The laser system 620 is then utilized to cut off excess material from the second end of the profile 40b, thereby providing and end wall 30 on the trim profile 1.

While the present disclosure has been described in detail in connection with only a limited number of embodiments or aspects, it should be readily understood that the present disclosure is not limited to such disclosed embodiments or aspects. Rather, the present disclosure can be modified to incorporate any number of variations, alterations, substitutions or equivalent arrangements not heretofore described, but which are commensurate in scope with the present disclosure. Additionally, while various embodiments or aspects of the present disclosure have been described, it is to be understood that aspects of the present disclosure may include only some of the described embodiments or aspects or combinations of the various embodiments or aspects. Accordingly, the present disclosure is not to be seen as limited by the foregoing description.

The invention is further described in the following items.

### Items

1. A method of providing an end wall part (30a) on an elongated metal trim profile (1), the method comprising

providing an elongated trim profile (1) of a metal plate material, the trim profile comprising one or more bends (10, 20a, 20b) extending in the longitudinal direction

(LD) of the trim profile (1), wherein said one or more bends (10, 20a, 20b) are arranged between side edges (2a, 2b) extending in the longitudinal direction (LD) of the trim profile, and wherein the one or more bends (10, 20a, 20b) shapes an interior surface (11) and an exterior surface (12) of the trim profile (1),

arranging and fixating a first part (40a) of the trim profile comprising said one or more bends (10, 20a, 20b) in a first fixation arrangement (100), and

arranging and fixating a second part (40b) of the trim profile in a second fixation arrangement (200),

providing a deep drawing operation by providing a relative displacement between a stamping tool (300) and at least one of the fixation arrangements (100, 200) in a direction transverse to the longitudinal direction (LD) of the trim profile (1) so that the stamping tool (300) moves into a working space (310), wherein the deep drawing operation forces a wall material of the trim profile into the working space (310) and thereby provides an end wall part (30a) on the trim profile (1).

2. A method according to item 1, wherein said working space (310) is provided between the first and second fixation arrangements (100, 200), and wherein the working space (310) extends in the longitudinal direction (LD) of the trim profile.

3. A method according to item 1 or 2, wherein the trim profile (1) comprises a plurality of bends (10, 20a, 20b) extending in the longitudinal direction (LD) of the trim profile (1), wherein the plurality of bends comprises a first bend (10) providing an elongated crest (16) on the exterior surface (12), and one or more second bends (20) placed between the first bend (10) and one of the side edges (2a, 2b) of the trim profile.

4. A method according to any of the preceding items, wherein the metal plate material of the trim profile (1) is a steel material such as a stainless steel material, for example a chromium-nickel stainless steel material.

5. A method according to item 4, wherein the steel material comprises at least 12% by weight of chrome (Cr).

6. A method according to any of the preceding items, wherein the material of the trim profile (1) has a wall thickness between 0.2 mm and 1.0 mm such as between 0.3 mm and 0.8 mm, preferably between 0.4 mm and 0.6 mm.

7. A method according to any of the preceding items, wherein the stamping tool (300) initiates the deep drawing operation by abutting and deforming a crest (16) of the trim profile, wherein the crest (16) is provided by the one or more bends (10, 20a, 20b) extending in the longitudinal direction (LD) of the trim profile (1).

8. A method according to any of the preceding items, wherein at least one (10) of said one or more bends (10, 20a, 20b) provides a first wall part (6) and a second wall part (7), wherein the bend angle (a1) between the first and second wall parts (6, 7) is between 45° and 150°, such as between 85° and 130°, for example between 100° and 120°.

9. A method according to any of items 3-8, wherein said method further comprises providing a cut out (3) operation prior to the deep drawing operation, wherein the cut out operation comprises providing a cut out (3) at the one or more second bends (20a, 20b) in an end wall area (13) in order to remove at least a part of the trim profile material at the one or more second bends (20a, 20b).

10. A method according to item 9, wherein the cut out (3) extends into the first and/or second wall part (6, 7).

11. A method according any of the preceding items, wherein the first fixation arrangement (100) provides a more firm fixation of the material of the trim profile (1) held by the first fixation arrangement (100), compared to the fixation of the trim profile provided by the second fixation arrangement (200).

12. A method according any of the preceding items, wherein the first fixation arrangement (100) strictly fixates the material of the trim profile (1) so as to substantially prevent the material of the trim profile held by the first fixation arrangement (200) from sliding into the working space during the deep drawing operation.

13. A method according to any of the preceding items, wherein the second fixation arrangement (200) is configured, such as controlled, adjusted and/or displaced, so as to provide a supply of trim profile material at the second part (40b) of the trim profile (1) towards the first fixation arrangement (100) during the deep drawing process.

14. A method according to any of the preceding items, wherein the first fixation arrangement (100) comprises a first set of support parts (110, 120), wherein the first set of support parts comprises
an interior support part (110) arranged in an interior space (14) of the trim profile (1), wherein the interior support part comprises a support surface (111) shaped to follow and support the interior surface (11) of the trim profile (1), and
an exterior support part (120) at the exterior surface (12), wherein the exterior support part comprises a support surface (121) shaped to follow and support on the exterior surface of the trim profile,
   wherein the first part (40a) of the trim profile is arranged and held between the interior support part (110) and the exterior support part (120) during the deep drawing operation.

15. A method according to any of the preceding items, wherein the second fixation arrangement (200) comprises a second set of support parts, wherein the second set of support parts comprises
an interior support part (210) arranged in an interior space (14) of the trim profile, wherein the interior support part comprises a support surface (211) shaped to follow and support the interior surface (11) of the trim profile (1), and
an exterior support part (220) at the exterior surface (12), wherein the exterior support part comprises a support surface (221) shaped to follow and support on the exterior surface of the trim profile, wherein the second part (40b) of the trim profile is arranged and held between the interior support part (110) and the exterior support part (120) during the deep drawing operation.

16. A method according to item 14 or 15, wherein said interior support part (110, 210) comprises one or more ridges (112) extending into a recess of the interior surface (11) of the trim profile which is shaped by one or more of said bends (10, 20a, 20b) extending in the longitudinal direction (LD) of the trim profile, and wherein the trim profile material at the one or more bends (10, 20a, 20b) supports on the one or more ridges (112) of the interior support part (110, 210) during the deep drawing operation.

17. A method according to item 14, 15 or 16 wherein said exterior support part (120, 220) comprises one or more recesses (122) in the support surface (121) into which a crest (16) of the trim profile extends during the deep drawing operation, wherein the crest (16) is a crest provided by one or more of said bends (10, 20a, 20b).

18. A method according to any of items 14-17, wherein said first interior support part (110, 210) comprises a corner support portion (113) having a corner shape configured to define the interior bending radius (r1) at the corner (31) at the transition between the trim profile (10) and the end wall part (30a) on the trim profile when the deep drawing operation is provided.

19. A method according to any of items 3-18, wherein the bends (10, 20a, 20b) of the trim profile (1) provides elongated wall parts extending in the longitudinal direction (LD) of the trim profile, said elongated wall parts comprising a first wall part (6) extending between a first bend (10) and a second bend (20a), a second wall part (7) arranged between said first bend (10) and the other side edge (2b) of the trim profile, and a third wall (5) part extending between the second bend (20a) and a first side edge (2a).

20. A method according to item 19, wherein a fourth wall part (8) extends between said other side edge (2b) and a further second bend (20b), wherein the further second bend (20b) is arranged between the first bend (10) and said other side edge (2b).

21. A method according to any of items 9-20, wherein the cut out (3) provides that the third wall part (5) and/or fourth wall part (8) is removed, such as substantially entirely removed, in the area of the cut out (3).

22. A method according to any of the preceding items, wherein the trim profile (1) has a width (W) and a height (H) wherein the width (W) and/or the height (H) is between 2 mm and 50 mm, such as between 3 mm and 20 mm, such as between 4 mm and 15 mm.

23. A method according to any of the preceding items, wherein the trim profile has a C-shape in cross section, where the C-shape is provided by a first bend (10) and further bends (20a, 20b) extending in the longitudinal direction (LD) of the trim profile.

24. A method according to any of the preceding items, wherein wall parts (5, 8) are removed at a position (15) of the trim profile proximate the end wall on the part of the trim profile that is used for the finalized trim profile, wherein said wall parts provides an entrance and/or exit area for an interior support part (110, 210) of the first and/or second fixation arrangement (100, 200).

25. A method according to any of the preceding items, wherein the inner bending radius (r1) at the end wall (3) which is provided due to the deep drawing operation is below 2 mm, such as below 1 mm, for example below 0.8 mm.

26. A method according to any of the preceding items, wherein a control system (330) controls a driver device (320), such as a servo motor or a stepper motor, and wherein the driver device displaces the stamping tool (300) into said working space (310) from an initial position (IPOS) to an end position (EPOS) in order to provide the deep drawing operation.

27. A method according to any of the preceding items, wherein the displacement speed (DSP) of the stamping tool (300) is varied during the deep drawing operation between an initial position (IPOS) where the deep drawing operation is initiated and the end position (EPOS) where the deep drawing operation is ended.

28. A method according to any of the preceding items, wherein the displacement speed (DSP) of the stamping tool (300) is reduced, such as gradually reduced, during the deep drawing operation.

29. A method according to any of the preceding items, wherein the displacement speed (DSP) of the stamping tool (300) is controlled by a control system (330) according to a displacement speed profile stored in a data storage (332).

30. A method according to any of the preceding items, wherein a further calibration of the end wall part (30a) is provided subsequent to the deep drawing operation, such as by means of a processing device (60) such as a roller rotating and supporting on the end wall part, in order to process the exterior surface of the end wall part (30).

31. A method according to any of the preceding items, wherein the one or more bends (10, 20a, 20b) extending in the longitudinal direction (LD) provides an interior space (14) in the elongated profile, wherein at least two, such as at least three, for example at least four walls (5, 6, 7, 8) of the trim profile extending in the longitudinal direction encloses the interior space (14), such as wherein the cross sectional area of the interior space (14) determined between said walls and enclosed by an envisaged bottom line (BL) drawn between the side edges (2a, 2b) of the profile extending in the longitudinal direction is between 0.5 cm² and 5 cm², such as between 1 cm² and 4 cm².

32. A method according to any of the preceding items, wherein the deep drawing operation provides a draw length (DL) by means of the stamping tool (300), wherein the draw length is at least 5 mm, such as at least 9 mm, for example at least 13 mm.

33. A method according to any of the preceding items, wherein the deep drawing operation provides that the end wall thickness of an area (34) of the end wall (30) is reduced by at least 10%, such as at least 20%, for example at least 30% when compared to the general material thickness of the trim profile.

34. A method according to any of the preceding items, wherein the corner radius (r2) at the transition between the stamping surface (301) of the stamping tool (300) and the end surface (300b) of the stamping tool (300) is larger than 5 mm such as larger than 10 mm, or even larger such as larger than 15 mm.

35. A method of providing an intermediate product of an end wall part (30a) on an elongated vehicular metal trim profile (1), such as a decorative trim profile, the method comprising providing an elongated trim profile (1) of a metal plate material, the trim profile comprising one or more bends (10, 20a, 20b) extending in the longitudinal direction (LD) of the trim profile (1), wherein said one or more bends (10, 20a, 20b) are arranged between side edges (2a, 2b) extending in the longitudinal direction (LD) of the trim profile, and wherein the one or more bends (10, 20a, 20b) shapes an interior surface (11) and an exterior surface (12) of the trim profile (1), arranging and fixating a first part (40a) of the trim profile comprising said one or more bends (10, 20a, 20b) in a first fixation arrangement (100), and arranging and fixating a second part (40b) of the trim profile in a second fixation arrangement (200), providing a deep drawing operation by providing a relative displacement between a stamping tool (300) and at least one of the fixation arrangements (100, 200) in a direction transverse to the longitudinal direction (LD) of the trim profile (1) so that the stamping tool (300) moves into a working space (310), wherein the deep drawing operation forces a wall material of the trim profile into the working space (310) and thereby provides an end wall part (30a) on the trim profile (1).

36. The method according to any of the preceding items, wherein the method further comprises the step of:
providing a pre-cutting operation prior to the deep-drawing operation and/or a post-cutting operation after the deep-drawing operation, wherein the pre-cutting operation and/or the post-cutting operation is provided by means of one or more laser systems (620).

37. A method of providing an end wall part on an elongated metal trim profile, the method comprising:

providing an elongated trim profile of a metal plate material, the trim profile comprising one or more bends extending in the longitudinal direction of the trim profile, wherein said one or more bends are arranged between side edges extending in the longitudinal direction of the trim profile, and wherein the one or more bends shapes an interior surface and an exterior surface of the trim profile,
arranging and fixating a first part of the trim profile comprising said one or more bends in a first fixation arrangement, and arranging and fixating a second part of the trim profile in a second fixation arrangement, and
providing an end wall forming operation, such as by bending and/or deep drawing the trim profile in a direction transverse to the longitudinal direction of the trim profile so that a wall material of the trim profile provides an end wall part on the trim profile, and
providing a pre-cutting operation prior to the end wall forming operation and/or a post-cutting operation after the end wall forming operation, wherein the pre-cutting operation and/or the post-cutting operation is provided by means of one or more laser systems (620).

38. The method according to any of the items 36-37, wherein the post-cutting operation comprises a cutting and/or grinding operation provided at the end wall part (30a).

39. The method according to any of the items 36-38, wherein the pre-cutting operation comprises the method step of providing a cut out (3).

40. The method according to any of the items 36-39, wherein the pre-cutting operation comprises the method step of providing the further cut out (15) according to item 24.

41. The method according to any of the items 24-40, wherein the further cut out (15) do not extend into the first and/or second wall part (6, 7).

42. The method according to items 24-40, wherein the further cut out (15) is extending to a line (4) providing the border between the first and second parts (40a, 40b).

43. The method according to any of the items 36-42, wherein the one or more laser systems (620) each comprises a laser source providing a laser beam (625) for cutting in said trim profile (1), wherein the laser source may be provided by a fiber laser, such as fiber laser utilizing nitrogen or argon as assist gas.

44. The method according to items 36-43, wherein at least one of the laser systems (620) is mounted on an industrial robot (610), and wherein the industrial robot (610) is arranged to automatically provide the pre- and/or post-cutting operation provided by the laser system (620) according to pre-determined settings, such as according to a predefined program code stored in a data storage.

45. The method according to item 44, wherein the industrial robot (610) is arranged to provide movement about a plurality of axes, preferably about six axes.

46. The method according to any of the items 44-45, wherein the industrial robot (610) is arranged to provide a pose repeatability down to 0.020 mm, such as down to 0.025 mm.

47. The method according to any of the items 36-46, wherein the method comprises the following sequence of steps:
providing a pre-cutting operation by means of the laser system (620) in order to provide a cut-out (3) and/or a further cut-out (15),
arranging and fixating the first part (40a) and the second part (40b),
providing the end wall forming operation, such as a deep-drawing operation, and subsequently
providing a post-cutting operation by means of the laser system (620) in order to remove excess material from the end wall part (30a).

48. The method according to any of the items 36-47, wherein in the step of providing a post-cutting operation by means of the laser system (620), excess material of the second end (40b) is fixed in position by means of a third fixation arrangement (800).

49. The method according to any of the items 1-48, wherein the method is provided at one or more work stations (501, 502, 503), wherein each work station (501, 502, 503) is arranged to perform at least one operation according to the method, such as a pre-cutting operation, a post-cutting operation, e.g. a cutting and/or grinding operation, an end wall forming operation, such as a deep-drawing operation and/or a calibration operation.

50. The method according to any of the items 36-49, wherein the pre-cutting operation and the post-cutting operation is provided at two separate work stations (501, 502, 503).

51. The method according to any of the items 36-50, wherein the pre-cutting operation is performed at a first working station (501), the fixating and deep drawing operation is performed at a second work station (502) and the post-cutting operation is performed at a third work station (503).

52. The method according to any of the items 44-51, wherein the industrial robot (610) is movably mounted on a displacement system, such as a rail system (600), so that the industrial robot (610) may be moved to one or more work stations (501, 502, 503) and provide said pre-cutting and post-cutting operation, such as at the first work station (501) and third work station (503).

52. The method according to any of the items 36-51, wherein the trim profile (1) is movably mounted on a conveyor system (700) providing the trim profile (1) to be moved to one or more work stations (501, 502, 503).

53. The method according to any of the items 1-52, wherein the method further comprises providing pre-determined settings including control commands for executing one or more method steps of the method, and wherein the method is automatically executed according to the pre-determined settings.

54. The method according to item 52 and 53, wherein the pre-determined setting further provides control commands to the rail system (600) and/or the conveyor system (700), so as to automatically transfer the trim profile (1) between work stations (501, 502, 503).

55. The method according to any of the items 14-18, wherein the interior support part (110) of the first set of support parts of the first fixation arrangement (100) and/or interior support part (210) of the second set of support parts of the second fixation arrangement (200) comprise a plurality of support elements (420, 430), which are movable relative to each other such that a collective width of the interior support part (110, 210) is changeable between a narrow and wide configuration.

56. The method according to any of the preceding items, wherein the elongated metal trim profile (1) is a elongated vehicular trim profile, preferably a decorative metal profile for vehicles, vessels or other purposes, such as a decorative metal profile for arrangement around a window of a vehicle or vessel.

57. An elongated trim profile (1) of a metal sheet material, wherein the trim profile comprising a plurality of bends (10, 20a, 20b) extending in the longitudinal direction (LD) of the trim profile (1), wherein said plurality of bends (10, 20a, 20b) are arranged between side edges (2a, 2b) extending in the longitudinal direction (LD) of the trim profile, and wherein the one or more bends (10, 20a, 20b) shapes an interior surface (11) and an exterior surface (12) of the trim profile (1), wherein the elongated trim profile (1) comprises an end wall (30) shaped in the material of the elongated trim profile (1), wherein the end wall (30) has been provided as a result of a deep drawing operation and consequently comprises an area (34) at the end wall which has a reduced wall thickness (Th2) compared to the general wall material thickness (Th1) of the trim profile (1).

58. The elongated trim profile (1) according to item 57, wherein the wall thickness of said area (34) of the end wall (30) with the reduced wall thickness is at least 10%, such as at least 20%, for example at least 30% lower than the general material thickness of the trim profile.

59. The elongated trim profile (1) according to any of items 57-58, wherein the general material thickness of the trim profile is between 0.2 mm and 1.0 mm such as between 0.3 mm and 0.8 mm, preferably between 0.4 mm and 0.6 mm.

60. The elongated trim profile (1) according to any of items 57-59, wherein the trim profile comprises a plurality of bends (10, 20a, 20b) extending in the longitudinal direction (LD) of the trim profile (1), wherein the plurality of bends comprises a first bend (10) providing an elongated crest, and one or more second bends (20) placed between the first bend (10) and one of the side edges (2a, 2b) of the trim profile.

61. The elongated trim profile (1) according to any of items 57-60, wherein the metal plate material of the trim profile (1) is a steel material such as a stainless steel material, for example a chromium-nickel stainless steel material.

62. The elongated trim profile (1) according to any of items 57-61, wherein the steel material comprises at least 12% by weight of chrome (Cr).

63. The elongated trim profile (1) according to any of items 57-62, wherein the trim profile has a width (W) and a height (H) wherein the width (W) and/or the height (H) is between 2 mm and 50 mm, such as between 3 mm and 20 mm, such as between 4 mm and 15 mm.

64. The elongated trim profile (1) according to any of items 57-63, wherein the trim profile has a C-shape in cross section, where the C-shape is provided by a first bend (10) and further second bends (20a, 20b) extending in the longitudinal direction (LD) of the trim profile.

65. The elongated trim profile (1) according to any of items 57-64, wherein the inner bending radius (r1) at the end wall (3) which is provided due to the deep drawing operation is below 3 mm, such as below 2 mm, for example below 1.5 mm.

66. The elongated trim profile (1) according to any of items 57-65, wherein at least one (10) of said bends (10, 20a, 20b) provides a first wall part (6) and a second wall part (7), wherein the bend angle (a1) between the first and second wall parts (6, 7) is between 45° and 150°, such as between 85° and 130°, for example between 100° and 120°.

67. The elongated trim profile (1) according to any of items 57-66, wherein the bends (10, 20a, 20b) extending in the longitudinal direction (LD) provides an interior space (14) in the elongated profile (1), wherein at least two, such as at least three, for example at least four walls (5, 6, 7, 8) of the trim profile extending in the longitudinal direction (LD) encloses the interior space (14), such as wherein the cross sectional area of the interior space (14) determined between said walls and enclosed by an envisaged bottom line (BL) drawn between the side edges (2a, 2b) of the trim profile, which side edges extends in the longitudinal direction (LD) is between 0.5 cm2 and 5 cm2, such as between 1 cm2 and 4 cm2.

68. The elongated trim profile (1) according to any of items 57-67, wherein the area (34) with reduced thickness on the end wall is located at a centre portion of the end wall located between an edge (32) of the end wall (30) and the bend providing the transition between the end wall and the part of the trim profile extending in the longitudinal direction (LD).

69. The elongated trim profile (1) according to any of the items 57-68, wherein the elongated trim profile is a vehicular elongated metal trim profile (1), preferably configured as a decorative metal profile for vehicles, vessels or other purposes, such as a decorative metal profile for arrangement around a window of a vehicle or vessel.

70. The elongated trim profile (1) according to any of items 57-69, wherein the end wall (30) is provided by means of a method according to any of items 1-56.

71. An elongated metal trim profile (1) with an end wall (30) provided by means of a method according to any of items 1-56.

72. The method according to any of the items 1-56, wherein the elongated trim profile is a vehicular elongated metal trim profile (1), preferably configured as a decorative metal profile for vehicles, vessels or other purposes, such as a decorative metal profile for arrangement around a window of a vehicle or vessel.

1. A method of providing an end wall part on an elongated vehicular metal trim profile, the method comprising:
providing an elongated vehicular metal trim profile of a metal plate material, the elongated vehicular metal trim profile comprising one or more bends extending in a longitudinal direction of the elongated vehicular metal trim profile, wherein the one or more bends are arranged between side edges extending in the longitudinal direction of the elongated vehicular metal trim profile, and wherein the one or more bends shapes an interior surface and an exterior surface of the elongated vehicular metal trim profile,
arranging and fixating a first part of the elongated vehicular metal trim profile comprising the one or more bends in a first fixation arrangement, and arranging and fixating a second part of the elongated vehicular metal trim profile in a second fixation arrangement,
providing a deep drawing operation by providing a relative displacement between a stamping tool and at least one of the first fixation arrangement and the second fixation arrangement in a direction transverse to the longitudinal direction of the elongated vehicular metal trim profile so that the stamping tool moves into a working space, wherein the working space is provided between the first fixation arrangement and the second fixation arrangement, and wherein the working space extends in the longitudinal direction of the elongated vehicular metal trim profile, wherein the deep drawing operation forces a wall material of the elongated vehicular metal trim profile into the working space and thereby provides an end wall part on the elongated vehicular metal trim profile, and
providing a cutting and/or grinding operation subsequent to the deep drawing operation in order to remove excess material from the deep drawing operation and separate the end wall part from the excess material.

2. The method according to claim 1, wherein the elongated vehicular metal trim profile comprises one or more bends extending in the longitudinal direction of the elongated vehicular metal trim profile, wherein the one or more of bends comprise a first bend providing an elongated crest on the exterior surface, and one or more second bends placed between the first bend and one of the side edges of the elongated vehicular metal trim profile.

3. (canceled)

4. (canceled)

5. (canceled)

6. (canceled)

7. The method according to claim 1, wherein the elongated vehicular metal trim profile is a decorative metal profile for vehicles, vessels or other purposes.

8. The method according to claim 2, wherein the method further comprises providing a cut out operation prior to the deep drawing operation, wherein the cut out operation comprises providing a cut out at the one or more second bends in an end wall area in order to remove at least a part of the elongated vehicular metal trim profile material at the one or more second bends.

9. (canceled)

10. The method according to claim 1, wherein the first fixation arrangement provides a firmer fixation of the metal plate material of the elongated vehicular metal trim profile held by the first fixation arrangement, compared to fixation of the elongated vehicular metal trim profile provided by the second fixation arrangement.

11. The method according to claim 1, wherein the first fixation arrangement strictly fixates the metal plate material of the elongated vehicular metal trim profile so as to substantially prevent the metal plate material of the elongated vehicular metal trim profile held by the first fixation arrangement from sliding into the working space during the deep drawing operation.

12. The method according to claim 1, wherein the second fixation arrangement is configured, so as to provide a supply of trim profile material at the second part of the elongated vehicular metal trim profile towards the first fixation arrangement during the deep drawing process.

13. The method according to claim 1, wherein
a relative displacement during the deep drawing operation in order to bring the stamping tool into the working space and deform the elongated vehicular metal trim profile to provide the end wall part is provided by keeping the first fixation arrangement and the second fixation arrangement in a fixed position and moving the stamping tool into the working space.

14. The method according to claim 1, wherein the first fixation arrangement comprises a first set of support parts, wherein the set of support parts comprises:
an interior support part arranged in an interior space of the elongated vehicular metal trim profile, wherein the interior support part comprises a first support surface shaped to follow and support the interior surface of the elongated vehicular metal trim profile; and
an exterior support part at the exterior surface, wherein the exterior support part comprises a second support surface shaped to follow and support on the exterior surface of the elongated vehicular metal trim profile
wherein the first part of the elongated vehicular metal trim profile is arranged and held between the interior support part and the exterior support part during the deep drawing operation.

15. The method according to claim 1, wherein the second fixation arrangement comprises a second set of support parts, wherein the second set of support parts comprises:
an interior support part arranged in an interior space of the elongated vehicular metal trim profile, wherein the interior support part comprises a first support surface shaped to follow and support the interior surface of the elongated vehicular metal trim profile; and
an exterior support part at the exterior surface, wherein the exterior support part comprises a second support surface shaped to follow and support on the exterior surface of the elongated vehicular metal trim profile,
wherein the second part of the elongated vehicular metal trim profile is arranged and held between the interior support part and the exterior support part during the deep drawing operation.

16. (canceled)

17. (canceled)

18. The method according to claim 14, wherein the first interior support part comprises a corner support portion having a corner shape configured to define an interior bending radius at a corner at a transition between the elongated vehicular metal trim profile and the end wall part on the elongated vehicular metal trim profile when the deep drawing operation is provided.

19. (canceled)

20. (canceled)

21. (canceled)

22. (canceled)

23. The method according to claim 1, wherein wall parts are removed at a position of the elongated vehicular metal trim profile proximate the end wall on a part of the elongated vehicular metal trim profile that is used for a finalized trim profile, wherein the wall parts provide an entrance and/or exit area for an interior support part of the first fixation arrangement and/or the second fixation arrangement.

24. (canceled)

25. (canceled)

26. (canceled)

27. (canceled)

28. (canceled)

29. (canceled)

30. (canceled)

31. (canceled)

32. (canceled)

33. (canceled)

34. The method according to claim 1, wherein the method further comprises:
providing a pre-cutting operation prior to the deep-drawing operation and/or a post-cutting operation after the deep-drawing operation, wherein the pre-cutting operation and/or the post-cutting operation is provided by one or more laser systems.

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. The method according to claim 12, wherein the second fixation arrangement is configured to allow the trim profile material at the second part of the elongated vehicular metal trim profile to slide towards the first fixation arrangement during the deep drawing process.

50. The method according to claim 14, wherein the interior support part of the set of support parts of the first fixation arrangement comprises a plurality of support elements, which are movable relative to each other such that a collective width of the interior support part is changeable between a narrow configuration and a wide configuration.

51. A method of providing an end wall part on an elongated vehicular metal trim profile being a decorative metal profile for arrangement around a window of a vehicle or vessel, the method comprising:
providing an elongated vehicular metal trim profile of a metal plate material, the elongated vehicular metal trim profile comprising one or more bends extending in a longitudinal direction of the elongated vehicular metal trim profile, wherein the one or more bends are arranged between side edges extending in the longitudinal direction of the elongated vehicular metal trim profile, and wherein the one or more bends shapes an interior surface and an exterior surface of the elongated vehicular metal trim profile;
arranging and fixating a first part of the elongated vehicular metal trim profile comprising the one or more bends in a first fixation arrangement, and arranging and fixating a second part of the elongated vehicular metal trim profile in a second fixation arrangement;
providing a deep drawing operation by providing a relative displacement between a stamping tool and at least one of the first fixation arrangement and the second fixation arrangement in a direction transverse to the longitudinal direction of the elongated vehicular metal trim profile so that the stamping tool moves into a working space, wherein the working space is provided between the first fixation arrangement and the second fixation arrangement, and wherein the working space extends in the longitudinal direction of the elongated vehicular metal trim profile, wherein the first fixation arrangement provides a firmer fixation of the metal plate material of the elongated vehicular metal trim profile held by the first fixation arrangement, compared to fixation of the elongated vehicular metal trim profile provided by the second fixation arrangement, wherein the deep drawing operation forces a wall material of the elongated vehicular metal trim profile into the working space and thereby provides an end wall part on the elongated vehicular metal trim profile; and
providing a cutting and/or grinding operation subsequent to the deep drawing operation in order to remove excess material from the deep drawing operation and separate the end wall part from the excess material.

52. An elongated trim profile of a metal sheet material, wherein the elongated trim profile comprises:
a plurality of bends extending in a longitudinal direction of the elongated trim profile, wherein the plurality of bends are arranged between side edges extending in the longitudinal direction of the elongated trim profile, and wherein the plurality of bends shapes an interior surface and an exterior surface of the elongated trim profile; and
an end wall shaped in the material sheet material of the elongated trim profile, wherein the end wall has been provided as a result of a deep drawing operation and consequently comprises an area at the end wall, which has a reduced wall thickness compared to a general wall material thickness of the elongated trim profile.

53. The elongated trim profile according to claim 52, wherein the reduced wall thickness of the area at the end wall is at least 10% lower than the general material thickness of the elongated trim profile.

54. The elongated trim profile according to claim 52, wherein the general material thickness of the elongated trim profile is between 0.2 mm and 1.0 mm.

55. The elongated trim profile according to claim 52, wherein an inner bending radius at the end wall, which is provided due to the deep drawing operation, is below 3 mm.
